(19) United States
(12) Patent Application Publication
(10) Pub. No.: US 2025/0301794 A1
(43) Pub. Date: Sep. 25, 2025

(54) STANDARD CELL LIBRARY AND SEMICONDUCTOR DEVICE

(71) Applicant: Kioxia Corporation, Tokyo (JP)

(72) Inventor: Atsushi NAKAYAMA, Yokohama (JP)

(73) Assignee: Kioxia Corporation, Tokyo (JP)

(21) Appl. No.: 18/974,882

(22) Filed: Dec. 10, 2024

(30) Foreign Application Priority Data
Mar. 19, 2024 (JP) 2024-043420

(51) Int. Cl. H10D 89/10; G06F 30/392

(52) U.S. Cl. CPC H10D 89/10; G06F 30/392

(57) ABSTRACT

According to one embodiment, a standard cell library has a first standard cell in which a first internal power supply wire is arranged, and a second standard cell in which a second internal power supply wire is arranged. When the first and the second standard cell are arranged adjacent in a second direction, the first and the second internal power supply wire are separated. The first standard cell has a first wiring region in which a first external power supply wire can be arranged, a first connectable position in which the first external power supply wire and the first internal power supply wire can be connected, a third wiring region in which a second external power supply wire can be arranged, and a third connectable position in which the second external power supply wire and the first internal power supply wire can be connected.

### CROSS REFERENCE TO RELATED APPLICATIONS

This application is based upon and claims the benefit of priority from prior Japanese Patent Application No. P2024-043420 filed on Mar. 19, 2024, the entire contents of which are incorporated herein by reference.

### FIELD

Embodiments described herein relate generally to a standard cell library and a semiconductor device.

### BACKGROUND

In the design of semiconductor integrated circuits, automation, high performance, and high functionality using computers are remarkable, and in particular, a method using standard cells is used in the layout design of semiconductor integrated circuits. In this method, when producing a circuit layout, a process called P & R (Placement and Routing) is used in which standard cells are arranged, and wires are connected to each other between arranged standard cells. In recent years, with the demand for higher speed and lower power consumption in circuits, more than one type of power supply is often used in one P & R region. On the other hand, a P & R tool does not have a function to optimize the position, size, and number of regions for each power supply. Therefore, in order to obtain an excellent layout in terms of electricity and area, it is necessary to adjust the position, size, and shape of the region for each power supply and repeat a P & R process. This requires a lot of time and work.

### BRIEF DESCRIPTION OF THE DRAWINGS

FIG. 1 is a configuration diagram of a semiconductor device according to a first embodiment.

FIG. 2 is a configuration diagram of a standard cell according to the first embodiment.

FIG. 3A is a cross-sectional view of the configuration of a standard cell according to the first embodiment.

FIG. 3B is a cross-sectional view of the configuration of a standard cell according to the first embodiment.

FIG. 4 is a first configuration diagram in which a standard cell according to the first embodiment and power supply wires are arranged.

FIG. 5A is a cross-sectional view of the first configuration in which a standard cell according to the first embodiment and power supply wires are arranged.

FIG. 5B is a cross-sectional view of the first configuration in which a standard cell according to the first embodiment and power supply wires are arranged.

FIG. 6A is a second configuration diagram in which a standard cell according to the first embodiment and power supply wires are arranged.

FIG. 6B is a third configuration diagram in which a standard cell according to the first embodiment and power supply wires are arranged.

FIG. 7 is a flowchart of a layout design method of a semiconductor device according to the first embodiment.

FIG. 8 is a schematic diagram of a layout design system of the semiconductor device according to the first embodiment.

FIG. 9 is a block configuration diagram of the layout design system in FIG. 8.

FIG. 10 is a configuration diagram of a semiconductor device according to a second embodiment.

FIG. 11 is a configuration diagram of a configuration in which a standard cell according to the second embodiment and power supply wires are arranged.

FIG. 12 is a configuration diagram of a semiconductor device according to a third embodiment.

FIG. 13A is a first configuration diagram in which a standard cell according to a third embodiment and power supply wires are arranged.

FIG. 13B is a second configuration diagram in which a standard cell according to the third embodiment and power supply wires are arranged.

FIG. 14A is a first configuration diagram in which a standard cell according to a fourth embodiment and power supply wires are arranged.

FIG. 14B is a second configuration diagram in which a standard cell according to the fourth embodiment and power supply wires are arranged.

FIG. 15 is a first configuration diagram of a semiconductor device according to a comparative example.

FIG. 16 is a configuration diagram of a standard cell according to a comparative example.

FIG. 17A is a cross-sectional view of a configuration of a standard cell according to a comparative example.

FIG. 17B is a cross-sectional view of a configuration of a standard cell according to a comparative example.

FIG. 18 is a second configuration diagram of a semiconductor device according to a comparative example.

FIG. 19 is a flowchart of a layout design method of semiconductor devices according to a comparative example.

### DETAILED DESCRIPTION

Certain Embodiments will be described with reference to the drawings. In the following description of the drawings, the same or similar parts are denoted by the same or similar reference numerals, and the description thereof will be omitted. The drawings are schematic.

Further, the embodiments described below are examples of devices and methods for embodying technical ideas, and do not specify the material, shape, structure, arrangement, or the like of each component. Various modifications may be made to this embodiment within the scope of the claims.

Certain embodiments provide a standard cell library and a semiconductor device capable of preventing repetition of work in a design process using a design device (such as a P & R tool or a layout design tool).

In general, according to the embodiment, a standard cell library has a first standard cell and a second standard cell having the following characteristics. The first standard cell has a first internal power supply wire arranged therein, and the second standard cell has a second internal power supply wire arranged therein. When the first standard cell and the second standard cell are arranged adjacent to each other in a second direction, the first internal power supply wire is separated from the second internal power supply wire. The first standard cell has a first wiring region in which a first external power supply wire can be arranged and which extends in a second direction, and a first connectable position in which the first external power supply wire and the first internal power supply wire can be connected. The second standard cell has a second wiring region in which a first external power supply wire can be arranged and which extends in a second direction, and a second connectable position in which the first external power supply wire and the second internal power supply wire can be connected. The first wiring region and the second wiring region are connectable adjacent to each other.

The first standard cell has a third wiring region in which a second external power supply wire can be arranged and which extends in the second direction, and a third connectable position in which the second external power supply wire and the first internal power supply wire can be connected. A first standard cell has a fourth wiring region in which a third external power supply wire can be arranged and which extends in the second direction, and a fourth connectable position in which the third external power supply wire and the third internal power supply wire can be connected.

Hereinafter, the standard cell library and the semiconductor device according to the present disclosure will be described with reference to the drawings.

### First Embodiment

### Structure of Semiconductor Device

In the following description, a semiconductor device is designed using a standard cell method. A first direction that is a direction of a height hu of standard cells 10, is defined as a Y direction, a second direction perpendicular to the direction of the height hu of the standard cells 10 on the sheet is defined as an X direction, and a third direction perpendicular to the X-Y plane is defined as a Z direction.

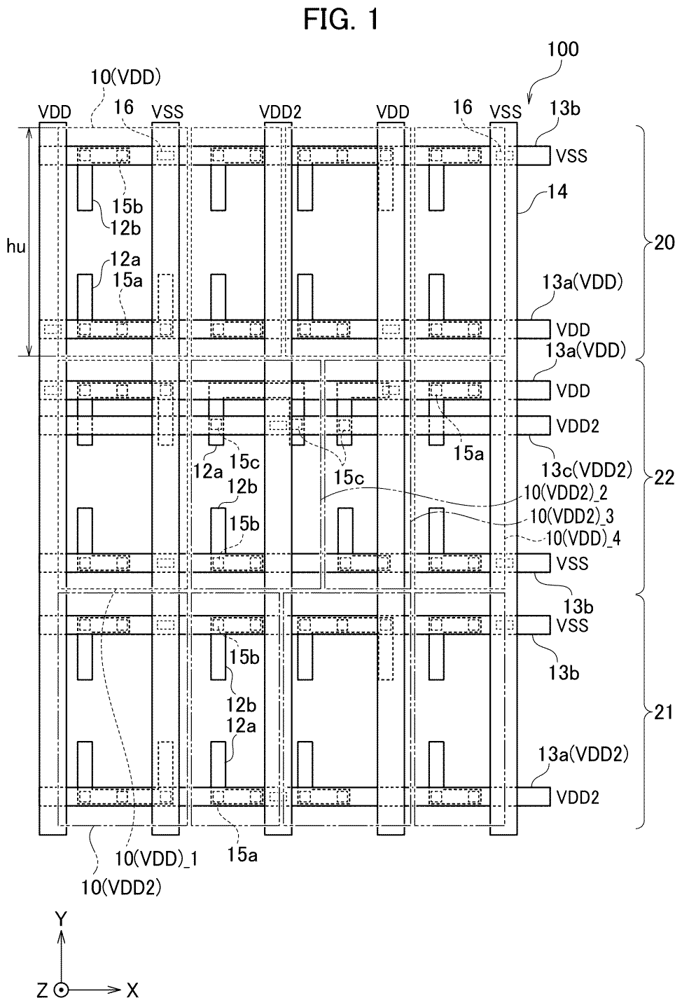

FIG. 1 is a configuration diagram of a semiconductor device according to a first embodiment. A semiconductor device 100 having a semiconductor integrated circuit in a larger scale is configured by arranging a plurality of standard cells 10 in contact by boundary lines to each other in two dimensions with the X direction and the Y direction, and connecting the standard cells 10 with wires. The semiconductor device 100 includes standard cell arrangement rows 20, 21, and 22, main power supply wires 13a and 13b of an M2 layer, a sub power supply wire 13c of the M2 layer, power supply wires 14 of an M3 layer, out-of-cell contacts 15a, 15b, and 15c, and contacts 16. The M1 layer, the M2 layer, and the M3 layer are first, second, and third metal wiring layers, respectively.

The standard cells 10 are arranged in the X direction in the standard cell arrangement rows 20, 21, and 22. The main power supply wires 13a, 13b and the sub power supply wire 13c are arranged in the X direction outside the standard cells 10 for each of the standard cell arrangement rows 20, 21, and 22. Here, “arranged outside the standard cells” means that they are not included in the components of the standard cells. Power supply wires 14 are arranged in the Y direction. The out-of-cell contacts 15a, 15b, and 15c are arranged outside the standard cells 10, and connect one of the intra-cell power supply wires 12a, 12b of the M1 layer to one of the main power supply wires 13a, 13b, and the sub power supply wire 13c of the M2 layer. The contacts 16 connect one of the main power supply wires 13a, 13b and the sub power supply wire 13c of the M2 layer to the power supply wires 14 of the M3 layer.

A plurality of standard cell arrangement rows arranged in the Y direction is called a standard cell arrangement group. In the standard cell arrangement group, the standard cells 10 are arranged in two dimensions with the X direction and the Y direction.

The standard cells 10 are logic circuits having functions of basic logical operations, and the logical operations are converted into cells to facilitate reuse. Examples of the standard cells 10 include INVERTER, NAND, NOR, EX-OR, BUFFER, and D-type flip-flops.

Generally, a logic circuit uses a pair of power supplies, one power supply on a high potential side, and one power supply on a low potential side. The standard cells 10 in FIG. 1 use a first power supply VDD or a third power supply VDD2 separated from the first power supply VDD as a power supply on the high potential side of the logic circuit, and a second power supply VSS as a power supply on the low potential side of the logic circuit.

The third power supply VDD2 is, for example, a power supply with a potential lower than the first power supply VDD, and is used in a logic circuit having an allowance in operation speed for the purpose of reducing power consumption. In another example, the third power supply VDD2 is a power supply capable of cutting off the power supply to the logic circuit while the first power supply VDD is supplied, and is used for the purpose of reducing standby power by cutting off the power supply to the logic circuit during standby of the semiconductor device.

The main power supply wires 13a that supply the first power supply VDD are denoted as main power supply wires 13a (VDD), and the main power supply wires 13a that supply the third power supply VDD2 is denoted as main power supply wires 13a (VDD2). The sub power supply wire 13c that supplies the third power supply VDD2 is denoted as a sub power supply wire 13c (VDD2).

The configuration of the standard cells 10 is the same regardless of whether the first power supply VDD or the third power supply VDD2 is used. When the standard cells 10 are arranged, the standard cells 10 are connected to a power supply to be used, outside the standard cells 10. When the standard cells 10 use the first power supply VDD as a power supply on the high potential side, they are denoted as standard cells 10 (VDD), and when the standard cells 10 use the third power supply VDD2, they are denoted as standard cells 10 (VDD2).

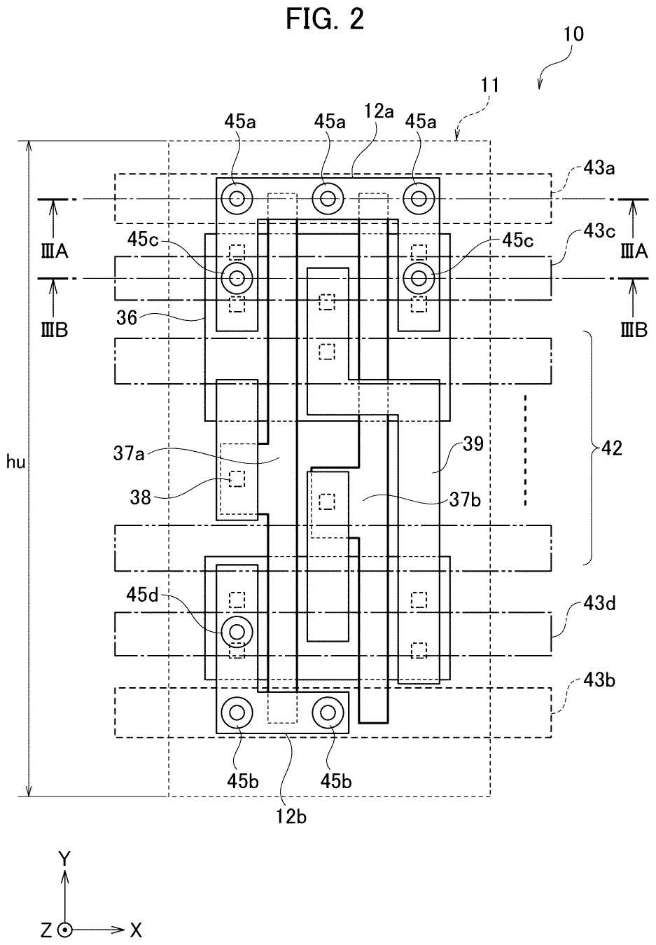

FIG. 2 is a configuration diagram of each standard cell 10 according to the first embodiment. As an example, a two-input NAND circuit is illustrated. The standard cell 10 defined by a rectangular region has a boundary line 11 surrounding upper, lower, left, and right sides. A dimension in the Y direction is the height per unit hu, and a dimension in the X direction varies depending on types of standard cells.

The standard cell 10 has internal power supply wires, referred to as intra-cell power supply wires. The standard cell 10 includes intra-cell power supply wires 12a and 12b of the M1 layer, an element isolation boundary line 36, gate layers 37a and 37b, contacts 38 for connecting the M1 layer to the gate layers or the M1 layer to the diffusion layer, and the signal line 39 of the M1 layer. A part of a region surrounded by the element isolation boundary line 36 is not overlapped by the gate layers 37a and 37b when viewed in the Z direction. The part is a P-type diffusion layer or an N-type diffusion layer. The standard cell 10 further includes a signal line wiring region 42 of the M2 layer, out-of-cell wiring regions 43a, 43b, 43c, and 43d of the M2 layer, and power supply access points 45a, 45b, 45c, and 45d.

The out-of-cell wiring regions 43a, 43b, 43c, and 43d of the M2 layer are regions in which external power supply wires or signal wires of the M2 layer can be arranged outside a standard cell. The external power supply wires arranged in the out-of-cell wiring regions 43a and 43b of the M2 layer are referred to as the main power supply wires 13a and 13b, and the external power supply wires arranged in the out-of-cell wiring regions 43c and 43d of the M2 layer are referred to as the sub power supply wire 13c and a sub power supply wire 13d.

The power supply access points 45a, 45b, 45c, and 45d indicate positions in which the out-of-cell contacts 15a, 15b, 15c, and an out-of-cell contact 15d can be arranged outside the standard cell 10. The out-of-cell contacts 15a, 15b, 15c, and 15d connect one of the intra-cell power supply wires 12a and 12b of the M1 layer to one of the main power supply wires 13a and 13b, and the sub power supply wires 13c and 13d of the M2 layer. In other words, the power supply access points 45a, 45b, 45c, 45d are connectable positions of the intra-cell power supply wires 12a, 12b of the M1 layer, the main power supply wires 13a, 13b of the M2 layer, and the sub power supply wires 13c, 13d. The power supply access points 45a, 45b, 45c, 45d do not have a physical substance, but are data elements of the standard cell before being arranged.

The intra-cell power supply wires 12a, 12b of the M1 layer are formed by combining a first portion of the intra-cell power supply wires arranged in the Y direction, and a second portion of the intra-cell power supply wires arranged in the X direction. The first portion of the intra-cell power supply wires arranged in the Y direction is connected to a P-type diffusion layer of a PMOS or an N-type diffusion layer of an NMOS, and further connected to either the main power supply wires 13a, 13b of the M2 layer or the sub power supply wires 13c, 13d. The second portion of the intra-cell power supply wires arranged in the X direction is arranged at a position overlapping the out-of-cell wiring region 43a or the out-of-cell wiring region 43b of the M2 layer, as seen in the Z direction. The second portion of the intra-cell power supply wires arranged in the X direction is connected to the main power supply wires 13a or the main power supply wires 13b of the M2 layer, or is connected to neither the main power supply wires 13a, 13b nor the sub power supply wires 13c, 13d.

The intra-cell power supply wire 12a of the M1 layer can have the power supply access points 45a in a part of the first portion of the intra-cell power supply wires arranged in the Y direction, which overlaps the out-of-cell wiring region 43a of the M2 layer, as seen in the Z direction, and in the second portion of the intra-cell power supply wires arranged in the X direction. Therefore, the number of power supply access points 45a is larger than the number of the first portion of the intra-cell power supply wires 12a arranged in the Y direction. Similarly, the number of power supply access points 45b is larger than the number of the first portion of the intra-cell power supply wires 12b arranged in the Y direction.

When the standard cell 10 is arranged, the corresponding out-of-cell contacts 15a or 15c are exclusively arranged on either of the power supply access points 45a or 45c. In addition, the corresponding out-of-cell contact 15b or the corresponding out-of-cell contact 15d is exclusively arranged on one of the power supply access points 45b and 45d. When one of the out-of-cell contacts 15a, 15b, 15c, and 15d is arranged, each of the power supply access points 45a, 45b, 45c, and 45d is replaced with a physical substance having one of the out-of-cell contacts 15a, 15b, 15c, and 15d, or an insulating film arranged thereon.

The positions of the out-of-cell wiring regions 43a, 43b, 43c, and 43d of the M2 layer in the Y direction are substantially equal in the plurality of standard cells 10. Therefore, when the standard cells 10 are arranged in contact with each other by each boundary line 11 in the X direction by a P & R process, the out-of-cell wiring regions 43a, 43b, 43c, and 43d of the standard cells 10 adjacent to each other are connected by each boundary line 11. Thus, outside the standard cells 10, the main power supply wires 13a, 13b and the sub power supply wires 13c, 13d of the M2 layer in the X direction can be arranged so as to pass through substantially predetermined positions in the Y direction of the standard cell arrangement rows.

A region sandwiched between the out-of-cell wiring regions 43c, 43d of the M2 layer is referred to as a signal line wiring region 42 of the M2 layer, and can be used to arrange the signal lines of the M2 layer in the X direction outside the standard cells 10.

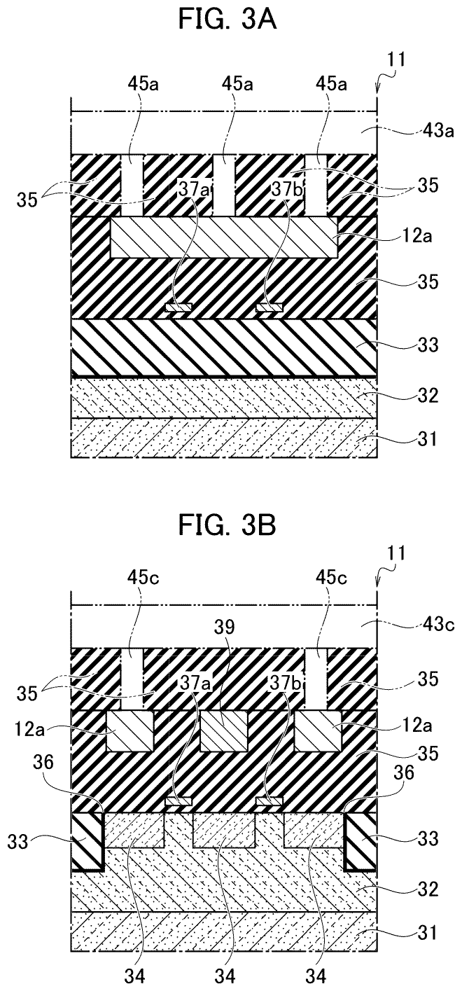

FIGS. 3A and 3B are cross-sectional views of the standard cell 10 according to the first embodiment. FIG. 3A illustrates a cross-sectional view along IIIA-IIIA in FIG. 2, and FIG. 3B illustrates a cross-sectional view along IIIB-IIIB.

In the cross-sectional view along IIIA-IIIA illustrated in FIG. 3A, the standard cell 10 has a P-type semiconductor substrate 31, an N-type well 32, an element isolation 33, an insulating film 35, the gate layers 37a, 37b, the intra-cell power supply wire 12a of the M1 layer, and the power supply access points 45a. The power supply access points 45a have no physical substance, but are illustrated in the cross-sectional view for convenience. The standard cell 10 further has the out-of-cell wiring region 43a of the M2 layer on a top surface of the insulating film 35 and the power supply access points 45a.

In the cross section along IIIB-IIIB illustrated in FIG. 3B, the standard cell 10 has the P-type semiconductor substrate 31, the N-type well 32, the element isolation 33, a P-type diffusion layer 34, the insulating film 35, the element isolation boundary line 36, and the gate layers 37a and 37b. The standard cell 10 further has the intra-cell power supply wire 12a of the M1 layer, the signal line 39 of the M1 layer, and the power supply access points 45c. The power supply access points 45c have no physical substance, but are illustrated in the cross-sectional view for convenience. The standard cell 10 further has the out-of-cell wiring region 43c of the M2 layer on an upper surface of the insulating film 35 and the power supply access points 45c.

The plurality of standard cells 10 illustrated in FIG. 2, FIG. 3A, and FIG. 3B are arranged in contact with each other in the X direction and the Y direction by each boundary line 11 thereof in the P & R process. Before the standard cells 10 are arranged, a power supply wire on a high potential side of the M2 layer is arranged in one or both of the out-of-cell wiring regions 43a and 43c of the M2 layer. A power supply wire on a low potential side of the M2 layer is arranged in one or both of the out-of-cell wiring regions 43b and 43d of the M2 layer. The standard cells 10 are arranged in a region in which a power supply wire on the high potential side and a power supply wire on the low potential side are arranged.

There are a plurality of combinations of a method of arranging a power supply wire in the out-of-cell wiring region of the M2 layer and a method of arranging an out-of-cell contact in a power supply access point. Among the plurality of combinations, those used in the semiconductor device 100 according to the first embodiment illustrated in FIG. 1 will be described below.

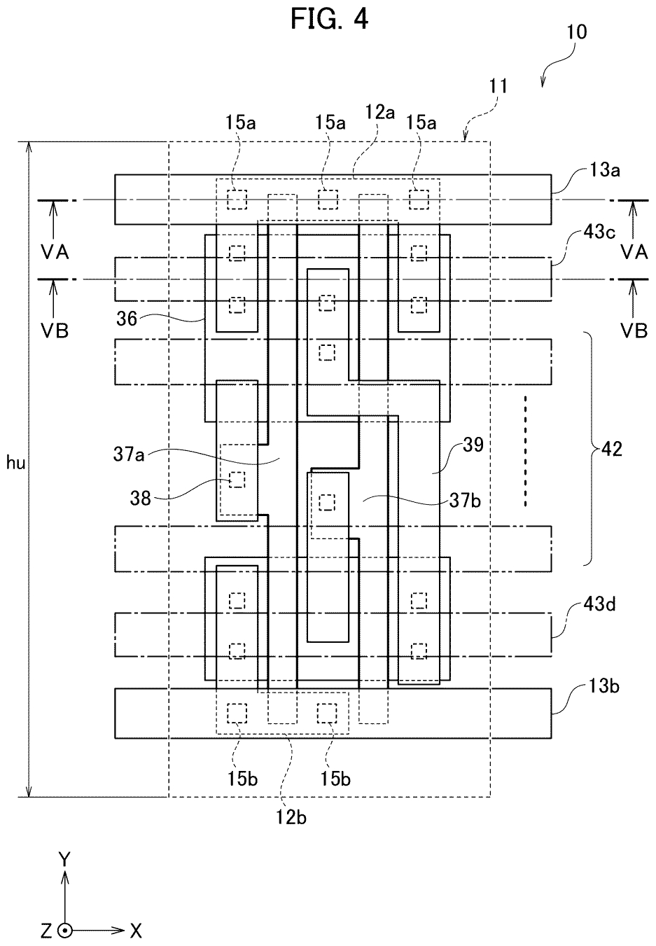

FIG. 4 is a first configuration diagram in which a standard cell according to the first embodiment and power supply wires are arranged. The first configuration diagram illustrates the standard cell 10 arranged in a region in which the power supply wires are arranged as follows: (1) The main power supply wires 13a and 13b are arranged in the out-of-cell wiring regions 43a and 43b of the M2 layer in FIG. 2, respectively. The main power supply wire 13a is either the first power supply VDD or the third power supply VDD2. The main power supply wire 13b is either the second power supply VSS or the fourth power supply VSS2. (2) No power supply wires are arranged in the out-of-cell wiring regions 43c and 43d of the M2 layer in FIG. 2.

The fourth power supply VSS2 is a power supply capable of cutting off the supply to the logic circuit even while the first power supply VDD and the second power supply VSS are being supplied, for example, and is used to reduce standby power by cutting off the supply to the logic circuit during standby of the semiconductor device.

The out-of-cell wiring regions 43c and 43d of the M2 layer in which no power supply wires are arranged, can be used to arrange the signal lines of the M2 layer. A region sandwiched between the out-of-cell wiring regions 43c and 43d of the M2 layer is the signal line wiring region 42 of the M2 layer.

The standard cell 10 uses the main power supply wire 13a and the main power supply wire 13b. When the standard cell 10 is arranged by P & R, the following processes (a) to (g) are performed.
(a) The main power supply wires 13a and 13b are selected as a pair of power supply wires used by the standard cell 10.
(b) The power supply access points 45a corresponding to the main power supply wire 13a used by the standard cell 10 are selected from the power supply access points 45a and 45c in FIG. 2.
(c) The out-of-cell contacts 15a are arranged on the power supply access points 45a that are selected, so that the intra-cell power supply wire 12a of the M1 layer is connected to the main power supply wire 13a of the M2 layer.
(d) An insulating film is arranged on the power supply access points 45c that are not selected, so that the signal lines arranged on the intra-cell power supply wire 12a of the M1 layer are separated from the out-of-cell wiring region 43c of the M2 layer.
(e) The power supply access points 45b corresponding to the main power supply wire 13b used by the standard cell 10 are selected from the power supply access points 45b and 45d in FIG. 2.
(f) The out-of-cell contacts 15b are arranged on the power supply access points 45b that are selected, so that the intra-cell power supply wire 12b of the M1 layer is connected to the main power supply wire 13b of the M2 layer.
(g) An insulating film is arranged on the power supply access point 45d that is not selected, so that the signal lines arranged on the intra-cell power supply wire 12b of the M1layer are separated from the out-of-cell wiring region 43d of the M2 layer.

In this way, one of the main power supply wire 13a and the sub power supply wire 13c is selected as the power supply wire on the high potential side, and is connected to the intra-cell power supply wire 12a of the M1 layer at either of the corresponding power supply access points 45a or 45c. Further, one of the main power supply wire 13b and the sub power supply wire 13d is selected as the power supply wire on the low potential side, and connected to the intra-cell power supply wire 12b of the M1 layer at either of the corresponding power supply access points 45b or 45d.

The power supply access points 45a, 45b, 45c, and 45d, on which one of the out-of-cell contacts 15a, 15b, 15c, and 15d or an insulating film are arranged, and replaced by a physical substance, are not illustrated in the drawings after the standard cells are arranged.

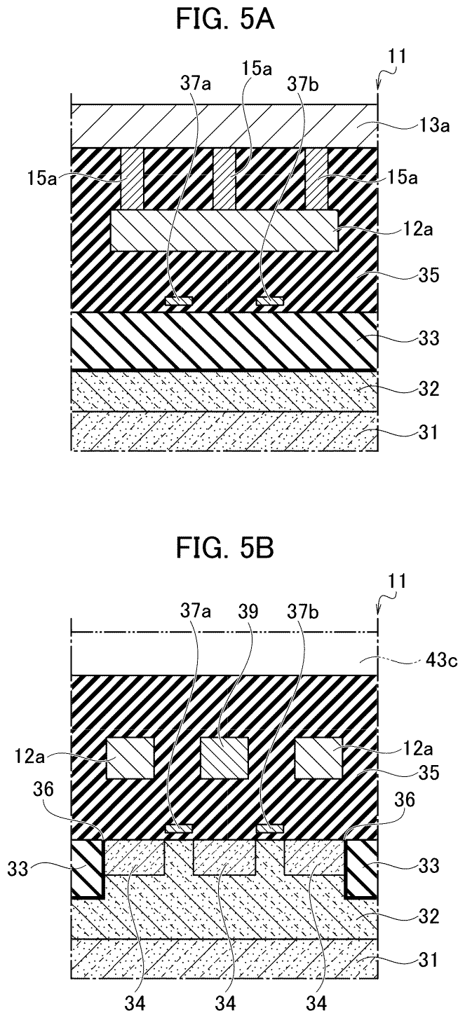

FIGS. 5A and 5B are cross-sectional views corresponding to the first configuration in which a standard cell according to the first embodiment illustrated in FIG. 4 and power supply wires are arranged. FIG. 5A is a cross-sectional view along VA-VA, and FIG. 5B is a cross-sectional view along VB-VB in FIG. 4.

The cross-sectional view along VA-VA illustrated in FIG. 5A is different from the cross-sectional view of the standard cell 10 according to the first embodiment illustrated in FIG. 3A in the following points: (1) The main power supply wire 13a of the M2 layer is arranged in the out-of-cell wiring region 43a of the M2 layer. (2) The out-of-cell contacts 15a are arranged at the positions of the power supply access points 45a, and the intra-cell power supply wire 12a of the M1 layer is connected to the main power supply wire 13a of the M2 layer. The other configurations are the same as the cross-sectional view of the standard cell 10 illustrated in FIG. 3A, and therefore the description thereof is omitted.

In the cross-sectional view along the line VB-VB illustrated in FIG. 5B, the standard cell 10 after being arranged is different from the cross-sectional view of the standard cell 10 according to the first embodiment illustrated in FIG. 3B in the following points: (1) An insulating film is arranged at the positions of the power supply access points 45c. The other configurations are the same as the cross-sectional configuration view of the standard cell 10 illustrated in FIG. 3B, and the description thereof will be omitted.

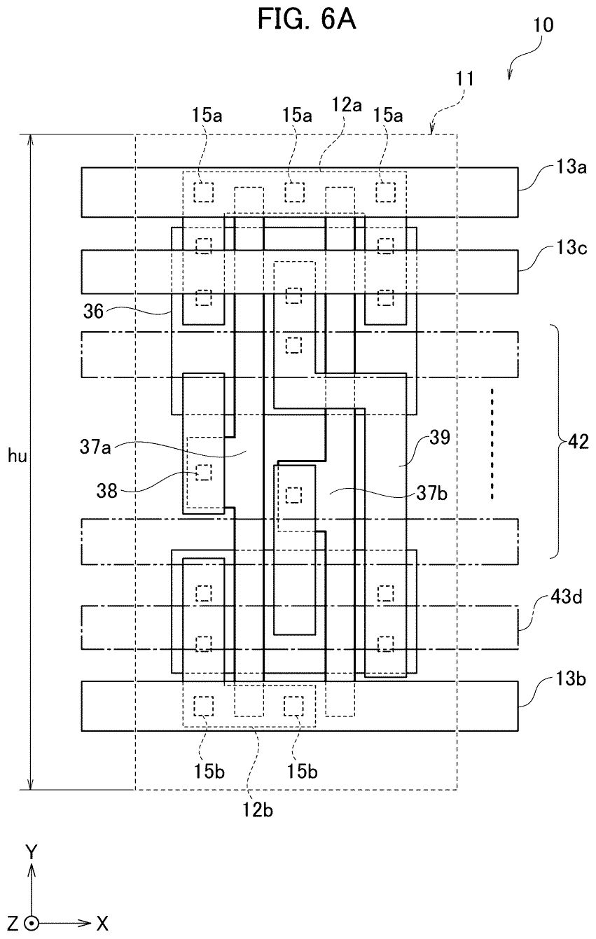

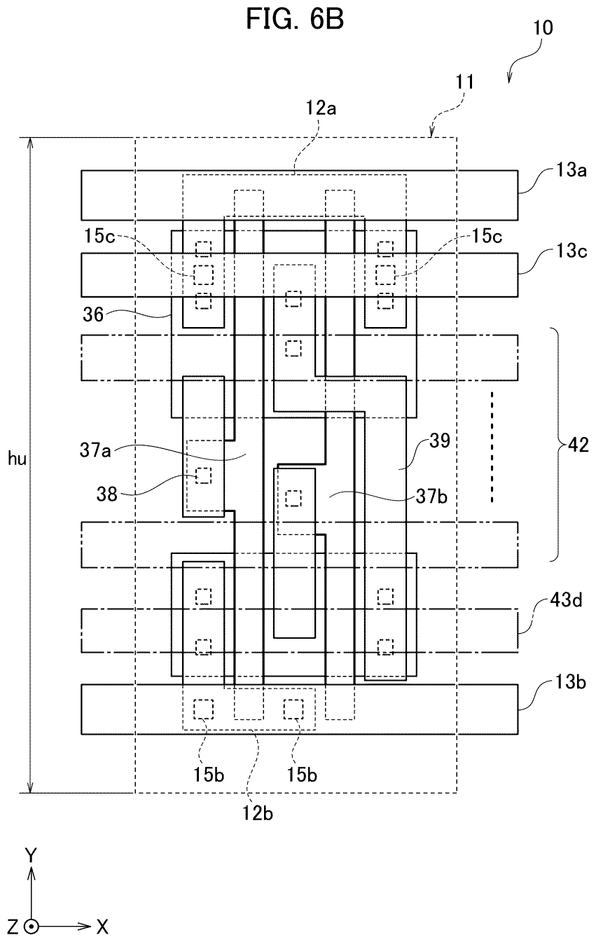

FIG. 6A is a second configuration diagram in which a standard cell according to the first embodiment and the power supply wires are arranged. The second configuration diagram illustrates the standard cell 10 arranged in a region in which the power supply wires are arranged as follows: (1) The main power supply wires 13a and 13b are arranged in the out-of-cell wiring regions 43a and 43b of the M2 layer in FIG. 2, respectively. The main power supply wire 13a is either the first power supply VDD or the third power supply VDD2, and the main power supply wire 13b is either the second power supply VSS or the fourth power supply VSS2. (2) The sub power supply wire 13c is arranged in the out-of-cell cell wiring region 43c of the M2 layer in FIG. 2. The sub power supply wire 13c is a power supply wire for supplying one of the first power supply VDD or the third power supply VDD2 which is different from the power supply supplied by the main power supply wire 13a. (3) No power supply wires are arranged in the out-of-cell wiring region 43d of the M2 layer in FIG. 2.

The out-of-cell wiring region 43d of the M2 layer, in which no power supply wires are arranged, can be used to arrange signal lines of the M2 layer. A region sandwiched between the sub power supply wires 13c and the out-of-cell wiring region 43d of the M2 layer is the signal line wiring region 42 of the M2 layer.

The standard cell 10 uses a main power supply wire 13a and a main power supply wire 13b. The second configuration diagram illustrated in FIG. 6A is different from the first configuration diagram illustrated in FIG. 4 in that not only the main power supply wire 13a but also the sub power supply wire 13c are arranged as power supply wires on a high potential side. In relation to the difference, the process (d) performed when the standard cell 10 is arranged in the first configuration diagram illustrated in FIG. 4 separates the intra-cell power supply wire 12a of the M1 layer and the sub power supply wire 13c in the second configuration diagram illustrated in FIG. 6A. The description thereof will be omitted as other parts are the same as the first configuration diagram illustrated in FIG. 4.

FIG. 6B is a third configuration diagram in which a standard cell according to the first embodiment and power supply wires are arranged. In the third configuration diagram, the configuration of the power supply wires in a region in which the standard cell 10 is arranged, is the same as the second configuration diagram illustrated in FIG. 6A.

The third configuration diagram illustrated in FIG. 6B is different from the second configuration diagram illustrated in FIG. 6A in that the standard cell 10 uses not the main power supply wire 13a but the sub power supply wire 13c as a power supply wire on a high potential side. In relation to the difference, the processes (a) to (d) are performed when the standard cell 10 is arranged in the first configuration diagram as follows.
(a) The sub power supply wire 13c and the main power supply wire 13b are selected as a pair of power supply wires used by the standard cell 10.
(b) The power supply access points 45c corresponding to the sub power supply wire 13c used by the standard cell 10 are selected from the power supply access points 45a and 45c in FIG. 2A.
(c) The out-of-cell contact 15c is arranged at the power supply access points 45c that are selected, so that the intra-cell power supply wire 12a of the M1 layer is connected to the sub power supply wire 13c of the M2 layer.
(d) An insulating film is arranged on the power supply access points 45a that are not selected, so that the intra-cell power supply wire 12a of the M1 layer is separated from the main power supply wire 13a.

The configuration diagram and a cross-sectional view of the configuration of the standard cell 10, and the configuration diagram and a cross-sectional view in which the standard cell 10 and the power supply wires are arranged have been described. With these in mind, a configuration diagram of the semiconductor device 100 according to the first embodiment illustrated in FIG. 1 will be described in detail.

In the standard cell arrangement rows 20 and 21 illustrated in FIG. 1, the standard cells 10 are arranged in a state inverted in the Y direction with respect to FIG. 2. This is for the purpose of sharing the boundary wells of the standard cell arrangement rows that are arranged adjacent to each other in the Y direction in general, and reducing the layout area, but the arrangement may be made without the inversion.

In the standard cell arrangement row 20 illustrated in FIG. 1, a first configuration in which standard cells and power supply wires are arranged, as illustrated in FIG. 4 is used. The main power supply wires 13a (VDD) and 13b of the M2 layer are arranged outside the standard cells 10 in the out-of-cell wiring regions 43a and 43b of the M2 layer in FIG. 2. The standard cells 10 use the first power supply VDD, are referred to as the standard cells 10 (VDD). The standard cell arrangement row 20 includes a third standard cell 10 (VDD).

In the standard cells 10 of the standard cell arrangement row 20, the main power supply wires 13a (VDD) on the high potential side, and the intra-cell power supply wires 12a of the M1 layer, are connected. Therefore, the out-of-cell contacts 15a are arranged at the positions of the power supply access points 45a in FIG. 2 outside the standard cells 10. Further, the main power supply wires 13b on the low potential side, and the intra-cell power supply wires 12b of the M1 layer, are connected. Therefore, the out-of-cell contacts 15b are arranged at the positions of the power supply access points 45b in FIG. 2 outside the standard cells 10. The contacts 16 are arranged at the intersections of the main power supply wires 13a (VDD) and 13b of the M2 layer, and the power supply wires 14 of the M3 layer arranged in the Y direction.

The first configuration in which standard cells and power supply wires are arranged, as illustrated in FIG. 4, are used for the standard cell arrangement row 21 in FIG. 1. The standard cell arrangement row 21 is the same as the standard cell arrangement row 20 except that standard cells are denoted as the standard cells 10 (VDD2), since the standard cells 10 use the main power supply wires 13a (VDD2) for supplying the third power supply VDD2.

In the standard cell arrangement rows 20 and 21 in FIG. 1, the first configuration in which standard cells and power supply wires are arranged, as illustrated in FIG. 4 is used, and a pair of power supply wires consisting of one main power supply wire 13a on the high potential side and one main power supply wire 13b on the low potential side are arranged as the power supply wires. A region in which a pair of power supply wires are arranged as the power supply wires is called a first block, and the standard cell arrangement rows 20 and 21 in FIG. 1 belong to the first block.

In the standard cell arrangement row 22 in FIG. 1, a second configuration in which standard cells and power supply wires are arranged, as illustrated in FIG. 6A, and a third configuration in which standard cells and power supply wires are arranged, as illustrated in FIG. 6B, are used. The main power supply wires 13a (VDD), 13b, and the sub power supply wire 13c (VDD2) of the M2 layer are arranged outside the standard cells 10 in the out-of-cell wiring regions 43a, 43b and 43c of the M2 layer in FIG. 2.

In the standard cells 10 (VDD) _1 and 10 (VDD) _4 of the four standard cells 10 arranged in the standard cell arrangement row 22, the second configuration in which the standard cells and the power supply wires are arranged, as illustrated in FIG. 6A, are used. In the standard cells 10 (VDD) _1 and 10 (VDD) _4, the main power supply wires 13a (VDD) on the high potential side are connected to the intra-cell power supply wires 12a of the M1 layer. For this purpose, the out-of-cell contacts 15a are arranged outside the standard cells 10 at the positions of the power supply access points 45a in FIG. 2.

In the first standard cell 10 (VDD2) _2 and the second standard cell 10 (VDD2) _3, the third configuration in which a standard cell and power supply wires are arranged, as illustrated in FIG. 6B, is used. The first standard cell 10 (VDD) _2 has the first intra-cell power supply wire 12a as a first internal power supply wire, and the third intra-cell power supply wire 12b as a third internal power supply wire. In the first standard cell 10 (VDD2) _2, the sub power supply wire 13c (VDD2) on the high potential side, arranged in the out-of-cell wiring region 43c as the first wiring region extending in the X direction, and the first intra-cell power supply wire 12a of the M1, are connected. For this purpose, outside the first standard cell 10 (VDD) _2, the out-of-cell contacts 15c as the first contacts are arranged at the positions of the power supply access points 45c in FIG. 2 as the first connectable positions. In the first standard cell 10 (VDD) _2, the main power supply wires 13a (VDD) on the high potential side are arranged as the second external power supply wires in the out-of-cell wiring region 43a as the third wiring region. Outside the first standard cell 10 (VDD) _2, an insulating film is arranged at the positions of the power supply access points 45a in FIG. 2 as the third connectable positions. In the first standard cell 10 (VDD) _2, the main power supply wire 13b on the low potential side as a third external power supply wire arranged in the out-of-cell wiring region 43b as a fourth wiring region, and the third intra-cell power supply wire 12b of the M1 layer, are connected. For this purpose, the out-of-cell contacts 15b as the third contacts, are arranged outside the first standard cells 10 (VDD) _2 at the position of the power supply access points 45b in FIG. 2, as the fourth connectable positions.

The second standard cell 10 (VDD2) _3 has the second intra-cell power supply wire 12a as the second internal power supply wire. In the second standard cell 10 (VDD2) _3, the sub power supply wire 13c (VDD2) on the high potential side, arranged in the out-of-cell wiring region 43c as a second wiring region extending in the X direction, and the second intra-cell power supply wire 12a of the M1 layer, are connected. For this purpose, the out-of-cell contacts 15c as second contacts, are arranged outside the second standard cell 10 (VDD2) _3 at the positions of the power supply access points 45c in FIG. 2 as second connectable positions.

In the standard cell arrangement row 22 in FIG. 1, a pair of power supply wires consisting of the main power supply wire 13a on the high potential side as a second external power supply wire, and the main power supply wire 13b on the low potential side as a third external power supply wire, are arranged as the power supply wires. In the standard cell arrangement row 22, the sub power supply wire 13c on the high potential side is further arranged as a first external power supply wire. As power supply wires, a region in which the pair of power supply wires, and one or more power supply wires are arranged, is called a second block. The standard cell arrangement row 22 belongs to the second block.

Generally, each region divided according to the type of power supply to be used is called a power domain. In the semiconductor device 100 in FIG. 1, the standard cell arrangement row 20 is a region of the power domain of VDD-VSS in which the power supply wire of the first power supply VDD is arranged as the main power supply wire 13a on the high potential side, and the power supply wire of the second power supply VSS is arranged as main power supply wire 13b on the low potential side. The standard cell arrangement row 21 is a region of the power domain of VDD2-VSS in which the power supply wire of the third power supply VDD2 is arranged as the main power supply wire 13a on the high potential side, and the power supply wire of the second power supply VSS is arranged as the main power supply wire 13b on the low potential side.

In the standard cell arrangement row 22 located on the boundaries of the standard cell arrangement row 20 and the standard cell arrangement row 21, which are different power domains, the power supply wire of the first power supply VDD is arranged as the main power supply wire 13a, and the power supply wire of the third power supply VDD2 is arranged as the sub power supply wire 13c. In the standard cell arrangement row 22, either the main power supply wire 13a or the sub power supply wire 13c is selected as the power supply wire to be used for each standard cell 10. Then, a power supply access point corresponding to either the main power supply wire 13a or the sub power supply wire 13c used by the standard cell 10 is selected from the power supply access points 45a and 45c in FIG. 2. Either the main power supply wire 13a or the sub power supply wire 13c is connected to the intra-cell power supply wire 12a by arranging one of the corresponding out-of-cell contacts 15a and 15c in the power supply access points 45a or 45c that are selected.

A standard cell using either the first power supply VDD or the third power supply VDD2 can be arranged in the standard cell arrangement row 22. A region in which a standard cell using any of the power supplies can be arranged is called a buffer region of the power domain.

By using the standard cell arrangement row 22 as a buffer region of the power domain, the standard cell 10 (VDD) using the first power supply VDD can be arranged in a region in which the standard cell arrangement row 20 of the power domain of the VDD-VSS and the standard cell arrangement row 22 are combined. In addition, the standard cell 10 (VDD2) using the third power supply VDD2 can be arranged in a region in which the standard cell arrangement row 21 of the power domain of the VDD2-VSS and the standard cell arrangement row 22 are combined. This improves degrees of freedom of P & R in each power domain. Thus, the designer can reduce the frequency of repetition of P & R which include adjusting the position, size, and shape of each power domain again, and rearranging the power supply wires.

### Layout Design Method

A layout design method of the semiconductor device 100 according to the first embodiment will be described.

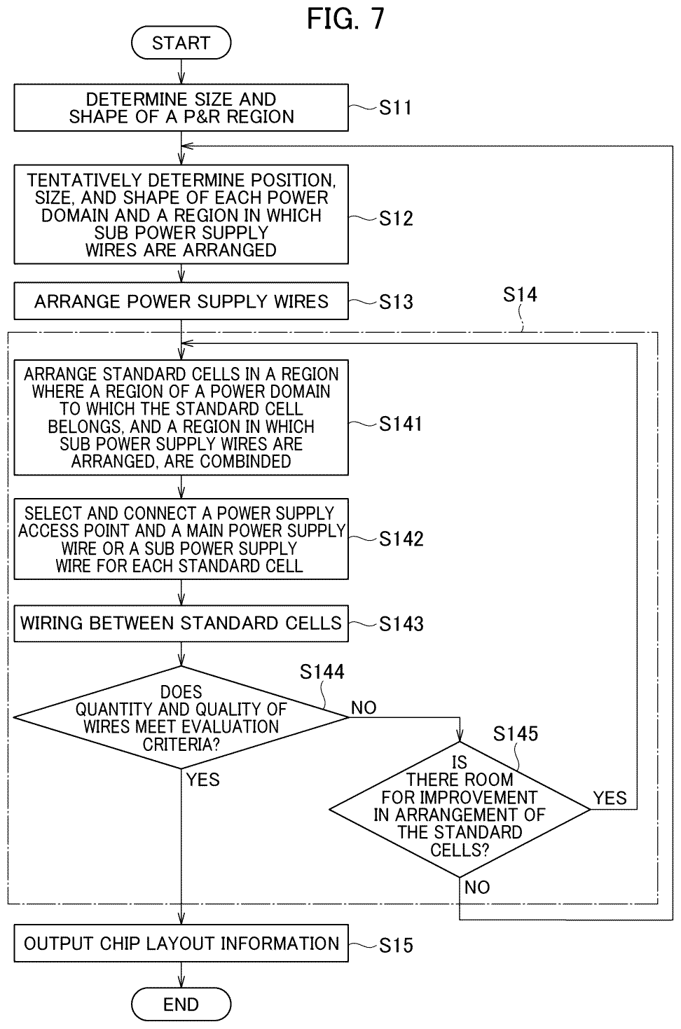

FIG. 7 is a flowchart of a layout design method of the semiconductor device 100 according to the first embodiment.

Before starting layout design, the logic circuits configured by the standard cells are logically synthesized by a logic synthesis tool, and converted into circuit diagram information configured by elements such as NMOS and PMOS. The circuit diagram information is then input at the start of the layout design.

The layout design is performed in the following steps. First, in step S11, a designer determines the size and shape of a region to be laid out by P & R. Next, in step S12, the designer tentatively determines the position, size, and shape of each power domain and a region in which the sub power supply wire is arranged. Next, in step S13, the designer arranges the power supply wire for each power domain and the region in which the sub power supply wire is arranged.

Next, in step S14, automatic layout is performed by a P & R process. The P & R process is divided as follows.

First, in step S141, a standard cell is arranged in a region combining a region of a power domain to which the standard cell belongs, and a region in which a sub power supply wire is arranged. Next, in step S142, a main power wire or a sub power wire used by the standard cell is selected for each standard cell, and a power supply access point corresponding to the selected main power wire or the sub power wire is selected. An intra-cell power wire is connected to the main power wire or the sub power wire by arranging an out-of-cell contact at a selected power supply access point. Next, in step S143, wiring is performed between the standard cells.

Next, in step S144, it is determined whether quantity and quality of wires arranged between power supply wires and standard cells satisfy evaluation criteria. The evaluation criteria include a degree of wiring congestion or the like.

In step S144, when the quantity and quality of the wires satisfy the evaluation criteria, the P & R process in step S14 is terminated, and proceed to step S15. In step S15, the designer outputs the layout information of the P & R region, and the layout design is finished.

On the other hand, in step S144, when the quantity or quality of the wiring does not satisfy the evaluation criteria, step S145 follows, in which it is determined whether there is room for improvement in the arrangement of the standard cells.

In step S145, when the quantity and quality of the wires, the number of times of P & R, or the like do not exceed predetermined criteria, it is determined that there is room for improvement in the arrangement of the standard cells. Then, the P & R process returns to step S141, and the arrangement and wiring of the standard cells are repeated so as to improve the quantity and quality of the wires.

On the other hand, in step S145, when the quantity or quality of the wires, the number of times of P & R, or the like exceeds predetermined criteria, it is determined that there is no room for improvement in the arrangement of the standard cells, since there is a low possibility that the quantity and quality of the wires will satisfy the evaluation criteria even if the P & R process is repeated. Then, returning to step S12, and based on an evaluation result in step S144, the designer sets the position, size, and shape of the regions in which the power domains and the sub power supply wire are arranged again, so as to improve the quantity and quality of the wires. Further, in step S13, the arrangement of the power supply wire is repeated, and the P & R process in step S14 is executed again.

In the flow of the layout design method of the semiconductor device 100 according to the first embodiment illustrated in FIG. 7, in step S141, the standard cells are arranged in a region in which the region of the power domain to which the standard cells belong, and the region in which the sub power supply wire is arranged, are combined. Then, in step S142, the main power supply wire or the sub power supply wire used by the standard cells is selected for each standard cell, to which the intra-cell power supply wires are connected. In the region in which the sub power supply wire is arranged, standard cells using any of the power supplies can be arranged. As a result, the degrees of freedom of P & R are improved.

By improving the degrees of freedom of P & R, the frequency in which it is determined in step S145 that there is no room for improvement in the arrangement of the standard cells can be reduced. Then, returning to step 12, the designer can reduce the frequency of adjusting the position, size, and shape of each power domain again, and that of rearranging power supply wires.

### Layout Design System

A layout design system of the semiconductor device 100 according to the first embodiment will be described.

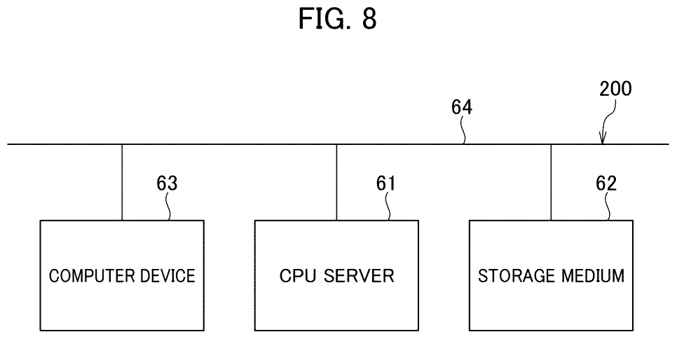

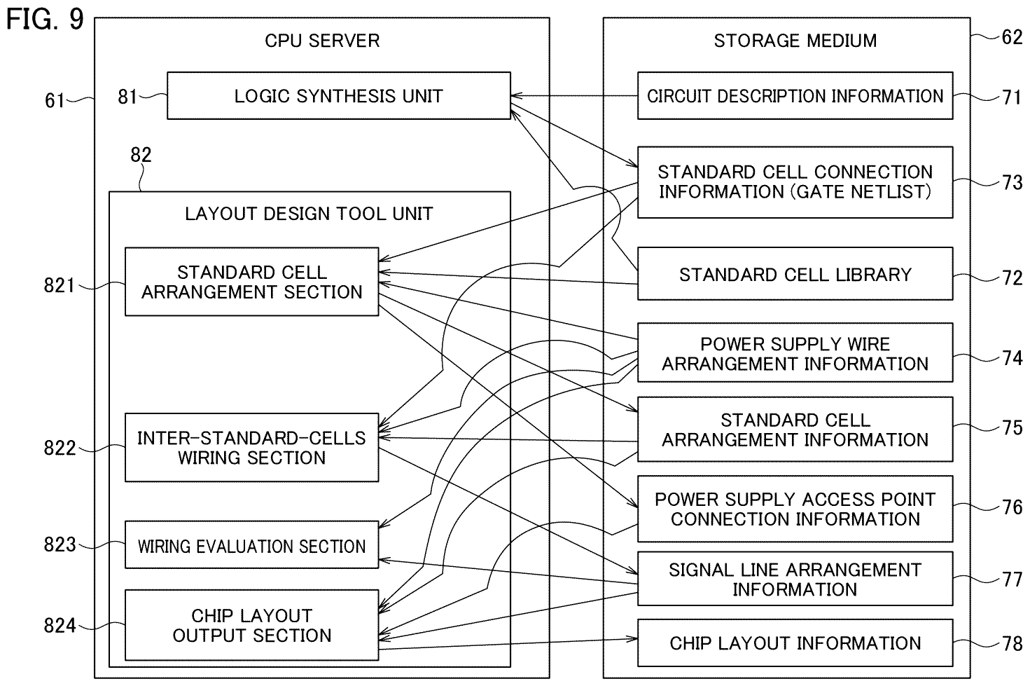

FIG. 8 is a schematic diagram of a layout design system 200 of the semiconductor device 100 according to the first embodiment. FIG. 9 is a block configuration diagram of the layout design system 200 in FIG. 8.

As illustrated in FIG. 8, the layout design system 200 includes a central processing unit (CPU) server 61, a storage medium 62, a computer device 63, and a network 64. In the following description, the central processing unit server 61 is also referred to as a CPU server 61.

The layout design system 200 connects the CPU server 61, the storage medium 62, and the computer device 63 operated by a user via the network 64. The CPU server 61 stores a computer program used for the layout design system 200. The storage medium 62 stores input information and output information necessary for executing a computer program used for the layout design system 200. The computer device 63 is operated by a user.

The CPU server 61 may be, for example, an engineering workstation, a mainframe, or a supercomputer. The storage medium 62 may be, for example, an external storage device of a hard disk, a semiconductor storage device of a memory, or a storage medium (media). The computer device 63 may be, for example, a personal computer (PC), a thin client terminal, a portable device, or a PDA (Personal Digital Assistant). The network 64 may be, for example, the Internet, an intranet, a LAN, a telephone communication network, or a leased line. However, the present invention is not limited to these examples.

As illustrated in FIG. 9, the CPU server 61 includes a logic synthesis unit 81 and a layout design tool unit 82 for executing a computer program used in the layout design system 200.

The logic synthesis unit 81 and the layout design tool unit 82 may be, for example, a processor of a CPU or a microprocessor. However, the present invention is not limited to these examples.

The logic synthesis unit 81 logically synthesizes standard cell connection information 73 (gate net list) based on circuit description information 71 and information in a standard cell library 72, and outputs the standard cell connection information 73, which has been logically synthesized, to the storage medium 62. The layout design tool unit 82 includes a standard cell arrangement section 821, an inter-standard-cells wiring section 822, a wiring evaluation section 823, and a chip layout output section 824.

The storage medium 62 includes the circuit description information 71, the standard cell library 72, and the standard cell connection information 73. The storage medium 62 further includes power supply wire arrangement information 74, standard cell arrangement information 75, power supply access point connection information 76, signal line arrangement information 77, and chip layout information 78. The standard cell library 72 includes a plurality of standard cells.

The designer tentatively determines the size and shape of the P & R region, and the position, size, and shape of a region in which each power domain and the sub power supply wires are arranged. Then the designer arranges the power supply wires, and outputs the power supply wire arrangement information 74 to the storage medium 62.

The standard cell arrangement section 821 arranges standard cells based on the standard cell library 72, the standard cell connection information 73, and the power supply wire arrangement information 74, and outputs the standard cell arrangement information 75 and the power supply access point connection information 76 to the storage medium 62.

The inter-standard-cells wiring section 822 arranges wires and connects the standard cells based on the standard cell connection information 73, the power supply wire arrangement information 74, and the standard cell arrangement information 75, and outputs the signal line arrangement information 77 to the storage medium 62.

The wiring evaluation section 823 evaluates the quantity and quality of the wires based on the power supply wire arrangement information 74 and the signal line arrangement information 77. When the quantity and quality of the wires satisfy the evaluation criteria, the wiring evaluation section 823 outputs a determination that the evaluation criteria are satisfied to the computer device 63. When the quantity or quality of the wires does not satisfy the evaluation criteria, and when it is determined that there is room for improvement in the arrangement of the standard cells, the wiring evaluation section 823 transmits a repetition command to the standard cell arrangement section 821. If it is determined that there is no room for improvement in the arrangement of the standard cells, an error determination result is output to the computer device 63.

The chip layout output section 824 outputs the chip layout information 78 to the storage medium 62 based on the instruction from the computer device 63, the power supply wire arrangement information 74, the standard cell arrangement information 75, the power supply access point connection information 76, and the signal line arrangement information 77.

### Effect of the First Embodiment

According to the first embodiment, in the layout design, in addition to a region in which a pair of main power supply wires are arranged, a region in which a pair of main power supply wires and one or more sub power supply wires on the high potential side are arranged, is partially provided. By partially providing a region in which the sub power supply wires are arranged, an increase in wiring area can be prevented. In the partially provided region, standard cells using any of the power supplies can be arranged. As a result, the degrees of freedom of P & R can be improved, and the frequency of a designer readjusting the position, size, and shape of each power domain, rearranging the power supply wires, and performing P & R again can be reduced, and the repetition of work in the design process can be prevented.

Here, a semiconductor device of a comparative example will be described in order to facilitate the understanding of the features of the present invention.

In the following description, as in the first embodiment of the present invention, a first direction, the direction of the height hu of standard cells 90, is defined as the Y direction, a second direction, perpendicular to the direction of the height hu of the standard cells 90 on the sheet, is defined as the X direction, and a third direction, perpendicular to the X-Y plane, is defined as the Z direction.

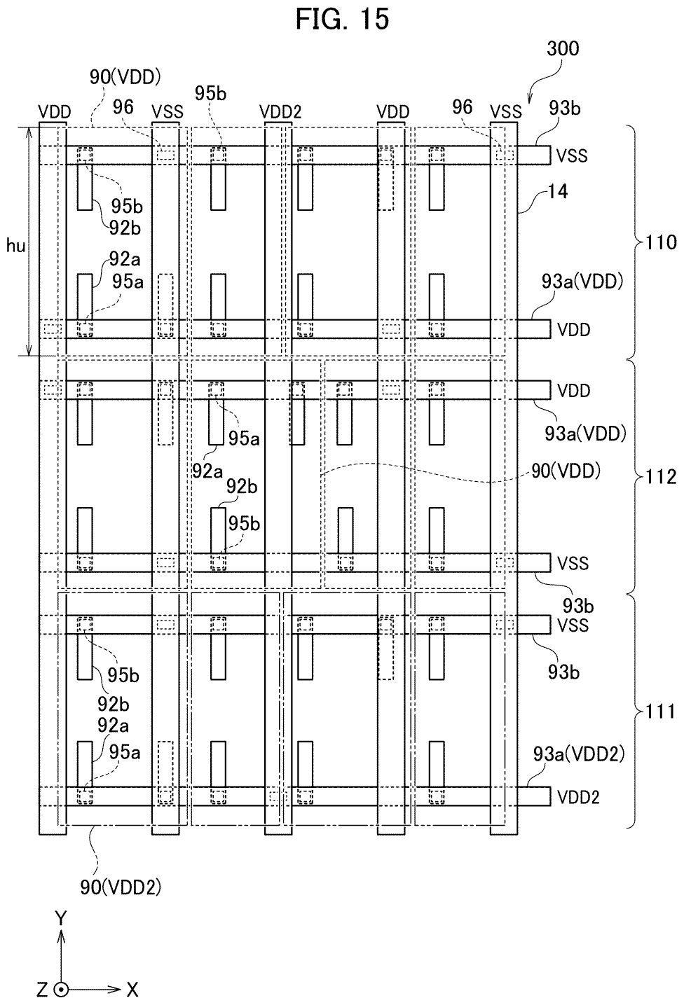

FIG. 15 is a first configuration diagram of a semiconductor device according to a comparative example. A semiconductor device 300 includes standard cell arrangement rows 110, 111, 112, the power supply wires 14 of the M3 layer, and contacts 96 for connecting the intra-cell power supply wires 93a, 93b of the M2 layer and the power supply wires 14. The standard cells 90 are arranged in the standard cell arrangement rows 110, 111, 112 in the X direction. The intra-cell power supply wires 93a, 93b of the M2 layer are arranged inside the standard cells in the X direction. Here, “arranged inside the standard cells” means that they are included in the components of the standard cells.

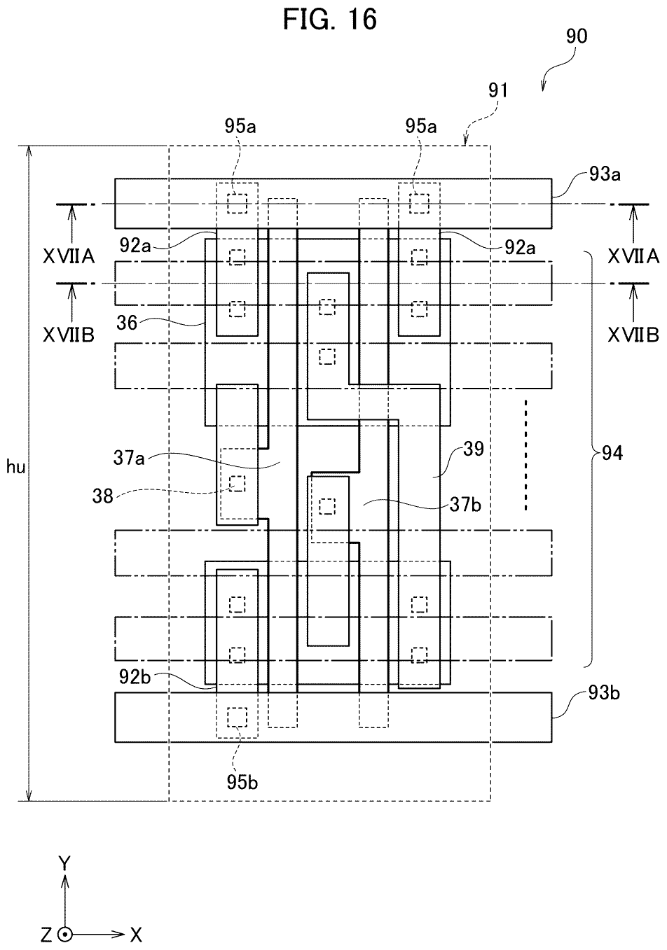

FIG. 16 is a configuration diagram of each standard cell 90 according to a comparative example. As an example, a two-input NAND circuit is illustrated. The standard cell 90 defined by a rectangular region has a boundary line 91 surrounding the upper, lower, left, and right sides.

The standard cell 90 includes intra-cell power supply wires 92a, 92b of the M1 layer, intra-cell power supply wires 93a, 93b of the M2 layer, intra-cell contacts 95a, 95b, and a signal line wiring region 94 of the M2 layer. The intra-cell contacts 95a, 95b are arranged inside the standard cell 90 and connect the intra-cell power supply wires 92a, 92b of the M1 layer to the intra-cell power supply wires 93a, 93b of the M2 layer. The standard cell 90 further includes the element isolation boundary line 36, the gate layers 37a, 37b, contacts 38 connecting the M1 layer to the gate layer or the M1 layer to a diffusion layer, and the signal line 39 of the M1 layer. A region in which the gate layers 37a and 37b do not overlap when viewed in the Z direction is a P-type diffusion layer or an N-type diffusion layer in a region surrounded by the element isolation boundary line 36.

The positions of the intra-cell power supply wires 93a and 93b of the M2 layer in the Y direction are substantially equal among the standard cells. Therefore, when the standard cells 90 are arranged in contact with each other by the boundary line 91 in the X direction by P & R process, the intra-cell power supply wires 93a and 93b of the M2 layer of the standard cells 90 adjacent to each other are connected by the boundary line 91.

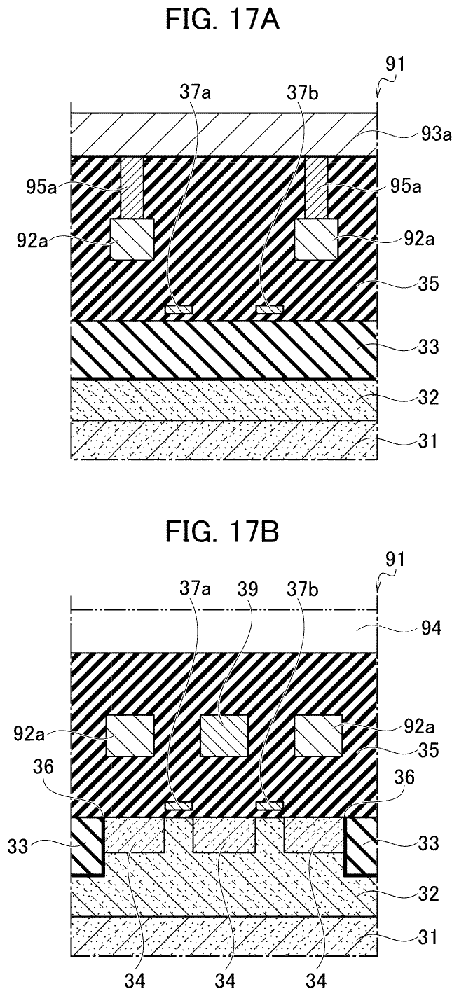

FIGS. 17A and 17B are cross-sectional views of each standard cell 90 according to a comparative example. FIG. 17A illustrates a cross section along XVIIA-XVIIA in FIG. 16, and FIG. 17B illustrates a cross section along XVIIB-XVIIB, respectively.

In the cross section along XVIIA-XVIIA illustrated in FIG. 17A, the standard cell 90 has the P-type semiconductor substrate 31, the N-type well 32, the element isolation 33, the insulating film 35, and the gate layers 37a and 37b. The standard cell 90 further has the intra-cell power supply wires 92a of the M1 layer, the intra-cell power supply wire 93a of the M2 layer, and the intra-cell contacts 95a for connecting the intra-cell power supply wires 92a of the M1 layer and the intra-cell power supply wire 93a of the M2 layer.

In the cross section along XVIIB-XVIIB illustrated in FIG. 17B, the standard cell 90 has the P-type semiconductor substrate 31, the N-type well 32, the element isolation 33, the P-type diffusion layer 34, the insulating film 35, the element isolation boundary line 36, and the gate layers 37a and 37b. The standard cell 90 further has an intra-cell power supply wires 92a of the M1 layer, the signal line 39 of the M1 layer, and the signal line wiring region 94 of the M2 layer.

In FIG. 15, in the standard cell arrangement rows 110 and 112, standard cells 90 (VDD) using the first power supply VDD are arranged adjacent to each other in the X direction. Thus, the intra-cell power supply wires 93a (VDD) of the M2 layer are connected over the entire rows, and the intra-cell power supply wires 93b of the second power supply VSS are connected over the entire rows. In the standard cell arrangement row 111, standard cells 90 (VDD2) using the third power supply VDD2 are arranged adjacent to each other in the X direction. Thus, the intra-cell power supply wires 93a (VDD2) of the M2 layer are connected over the entire row, and the intra-cell power supply wires 93b of the second power supply VSS are connected over the entire row.

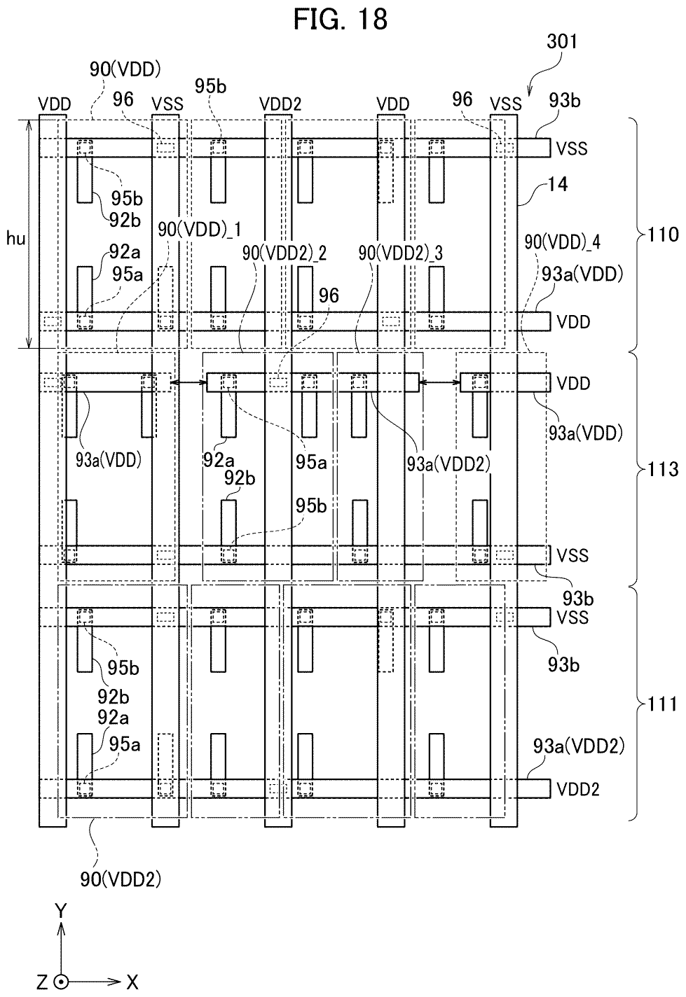

FIG. 18 is a second configuration diagram of a semiconductor device according to a comparative example. The semiconductor device 301 includes standard cell arrangement rows 110, 111, and 113, the power supply wires 14 of the M3 layer, and the contacts 96 for connecting the intra-cell power supply wires 93a, 93b of the M2 layer and the power supply wires 14. In the standard cell arrangement row 113, the standard cell 90 (VDD) and the standard cell 90 (VDD2) are arranged in the same standard cell arrangement row. If the standard cell 90 (VDD) and the standard cell 90 (VDD2) are arranged adjacent to each other in the X direction, the intra-cell power supply wire 93a (VDD) of the M2 layer and the intra-cell power supply wire 93a (VDD2) are connected, and the first power supply VDD and the third power supply VDD2 are short-circuited. Therefore, the standard cell 90 (VDD) and the standard cell 90 (VDD2) are arranged with an interval in the X direction.

The standard cell arrangement row 110, and standard cells 90 (VDD) _1 and 90 (VDD) _4 in the standard cell arrangement row 113, constitute a power domain of the VDD-VSS. The standard cells 90 (VDD2) _2 and 90 (VDD2) _3 in the standard cell arrangement row 113 and the standard cell arrangement row 111 constitute the power domain of the VDD2-VSS.

The standard cell 10 according to the first embodiment of the present invention differs from the standard cell 90 according to the comparative examples described above in the following points: (1) The standard cell 10 according to the first embodiment of the present invention does not have the intra-cell power supply wires 93a and 93b of the M2 layer, and the intra-cell contacts 95a and 95b. (2) The standard cell 10 according to the first embodiment of the present invention has the power supply access points 45a, 45b, 45c and 45d. (3) The standard cell 10 according to the present invention has portions arranged in the X direction so that the intra-cell power supply wires 12a and 12b of the M1 layer overlap the out-of-cell wiring regions 43a and 43b of the M2 layer when viewed in the Z direction.

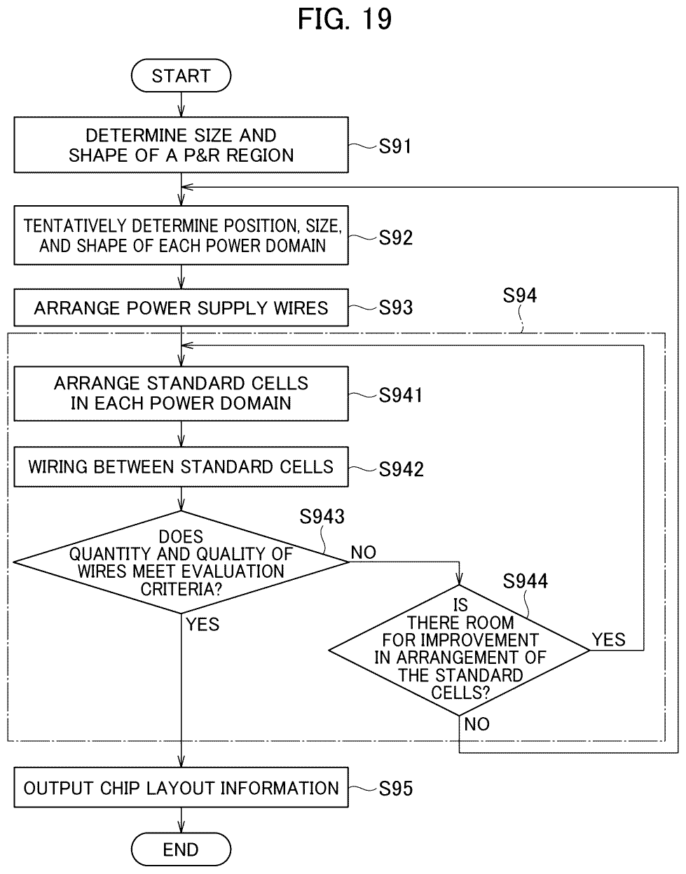

FIG. 19 is a flowchart of a layout design method of the semiconductor devices 300 and 301 according to a comparative example. This flowchart is common to the diagrams of the first and second configurations of the semiconductor devices according to the comparative examples.

The layout design is performed in the following steps. First, in step S91, a designer determines the size and shape of a region to be laid out by P & R. Next, in step S92, the designer tentatively determines the position, size, and shape of each power domain. Next, in step S93, the designer arranges power supply wires for each power domain.

Next, in step S94, automatic layout is performed by a P & R process.

The P & R process is divided as follows. First, in step S941, standard cells are arranged in each power domain. Next, in step S942, wiring between standard cells is performed.

Next, in step S943, it is determined whether quantity and quality of wires arranged between power supply wires and standard cells satisfy evaluation criteria. The evaluation criteria include a degree of wiring congestion or the like.

When quantity and quality of wires satisfy evaluation criteria in step S943, the P & R process in step S94 is terminated, and step S95 follows. In step S95, the designer outputs layout information of the P & R region, and the layout design is finished.

On the other hand, in step S943, when quantity and quality of wires do not satisfy the evaluation criteria, step S944 follows, and it is determined whether there is room for improvement in the arrangement of the standard cells.

In step S944, when quantity and quality of wires, the number of times of P & R, or the like do not exceed predetermined criteria, it is determined that there is room for improvement in the arrangement of the standard cells. Then, the P & R process returns to step S941, and arrangement and wiring of the standard cells are repeated so as to improve quantity and quality of wires.

On the other hand, in step S944, if quantity or quality of wires, the number of times the P & R has been performed, or the like exceeds predetermined criteria, it is determined that there is no room for improvement in the arrangement of the standard cells, since there is a low possibility that quantity and quality of wires will satisfy the evaluation standard even if the P & R process is repeated. Then, the process returns to step S92, and the designer sets the position, size, and shape of each power domain again so as to improve the quantity and quality of wires based on an evaluation result in step S943. Further, in step S93, the power supply wires are rearranged, and the P & R process in step 94 is executed again.

Based on the flow of the layout design method of the semiconductor devices 300 and 301 according to the above comparative examples, return to the first configuration diagram of the semiconductor device according to the comparative example in FIG. 15, and the second configuration diagram of the semiconductor device according to the comparative example in FIG. 18. In the first configuration diagram and the second configuration diagram according to the comparative examples, the degrees of freedom of the P & R are limited, since the P & R is performed after the arrangement of the power domains of the first power supply VDD and the third power supply VDD2 is determined in a previous stage of the P & R.

For example, in the first configuration diagram in FIG. 15, the place in which the standard cells 90 using the VDD2 can be arranged is limited to the standard cell arrangement row 111, which is the power domain of the VDD2-VSS. Therefore, in the evaluation after the P & R, if the quantity or quality of wires arranged in the standard cells 90 arranged in the standard cell arrangement row 111 does not satisfy the evaluation criteria, the degrees of freedom to rearrange the standard cells 90 are limited, and it is likely to be determined that there is no room for improvement. If it is determined that there is no room for improvement in the arrangement of the standard cells 90, the designer is required to adjust the size and shape of the power domain, and rearrange the power supply wire so as to enlarge the region of the power domain of the VDD2-VSS.

As an example of adjusting the size and shape of the power domain, replacement of a part of the power domain of the VDD-VSS with the power domain of the VDD2-VSS, is considered, as illustrated in the standard cell arrangement row 113 in the second configuration diagram in FIG. 18.

In order to separate the intra-cell power supply wire 93a (VDD) of the first power supply VDD of the M2 layer from the intra-cell power supply wire 93a (VDD2) of the third power supply VDD2 in the X direction, a designer moves the power domain to which the standard cells 90 (VDD) _1, 90 (VDD) _4 belong outward in the X direction. Then, a gap is inserted between the standard cell 90 (VDD) _1 and the standard cell 90 (VDD2) _2, and between the standard cell 90 (VDD2) _3 and the standard cell 90 (VDD) _4. The designer adjusts the arrangement of the power supply wires 14 of the M3 layer in the Y direction to ensure power supply capability to the separated intra-cell power supply wires 93a (VDD), 93a (VDD2) of the M2 layer.

When the layout area is increased by the designer's adjustment, the position and shape of the power domain and the arrangement of the power supply wires are adjusted to fit into a predetermined area and shape. Then, it is necessary to repeat the P & R.

Thus, when the adjustment of the position, size and shape of the power domain, the arrangement of the power supply wires and the P & R are repeated, a large amount of time and work is required.

In the semiconductor device 100 according to the first embodiment of the present invention, as compared with the semiconductor devices 300 and 301 according to the comparative examples described above, the degrees of freedom of the P & R are improved, and the repetition of the P & R process by adjusting the arrangement of the power domain and the power supply wires can be prevented.

Specifically, in addition to a region in which a pair of main power supply wires are arranged, a region in which a pair of main power supply wires and one or more sub power supply wires on the high potential side are arranged is partially provided. Then, for each standard cell, either the main power supply wire or the sub power supply wire used by the standard cell is selected. Further, among the plurality of power supply access points, a power supply access point corresponding to either the main power supply wire or the sub power supply wire used by the standard cell is selected. Then, a corresponding out-of-cell contact is arranged at the selected power supply access point, and either the main power supply wire or the sub power supply wire is connected to the intra-cell power supply wire. In this way, a standard cell using any of the power supplies can be arranged in the partially provided region, and the degrees of freedom of P & R are improved.

### Second Embodiment

### Structure of Semiconductor Device

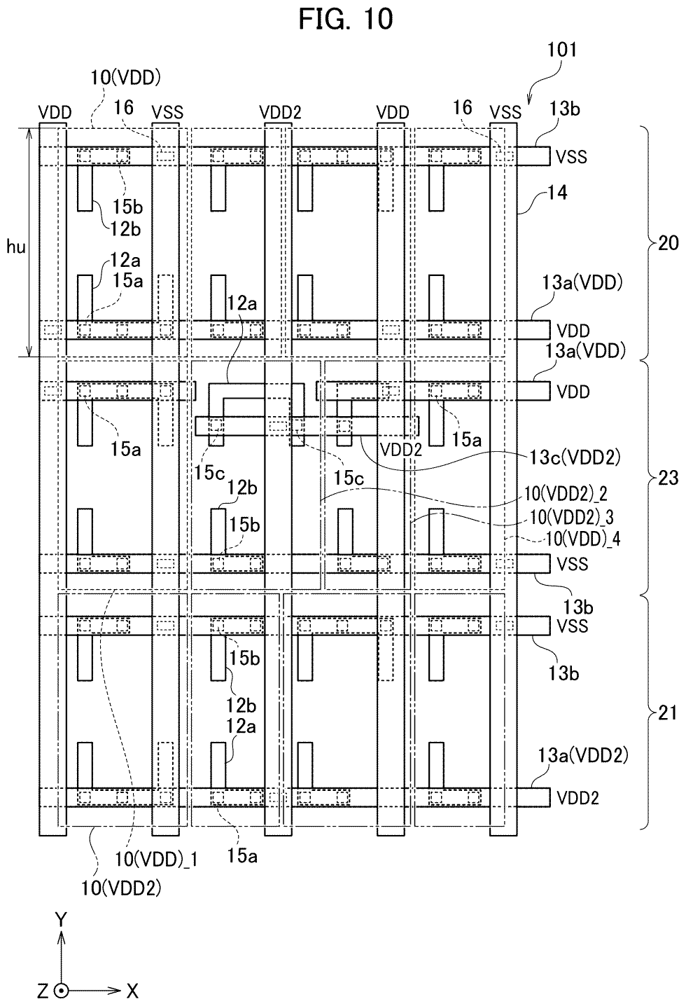

FIG. 10 is a configuration diagram of a semiconductor device according to a second embodiment. The semiconductor device 101 includes the standard cell arrangement rows 20, 21, and a standard cell arrangement row 23, the main power supply wires 13a and 13b of the M2 layer, the sub power supply wire 13c of the M2 layer, the power supply wires 14 of the M3 layer, the out-of-cell contacts 15a, 15b, and 15c, and the contacts 16.

The standard cells 10 are arranged in the X direction in the standard cell arrangement rows 20, 21, and 23. The main power supply wires 13a and 13b and the sub power supply wire 13c are arranged in the X direction outside the standard cells for each of the standard cell arrangement rows 20, 21, and 23. The power supply wires 14 are arranged in the Y direction. The out-of-cell contacts 15a, 15b, and 15c are arranged outside the standard cell, and connect one of the intra-cell power supply wires 12a and 12b of the M1 layer to one of the main power supply wires 13a, 13b and the sub power supply wires 13c of the M2 layer. The contacts 16 connect one of the main power supply wires 13a and 13b and the sub power supply wire 13c of the M2 layer to the power supply wires 14 of the M3 layer.

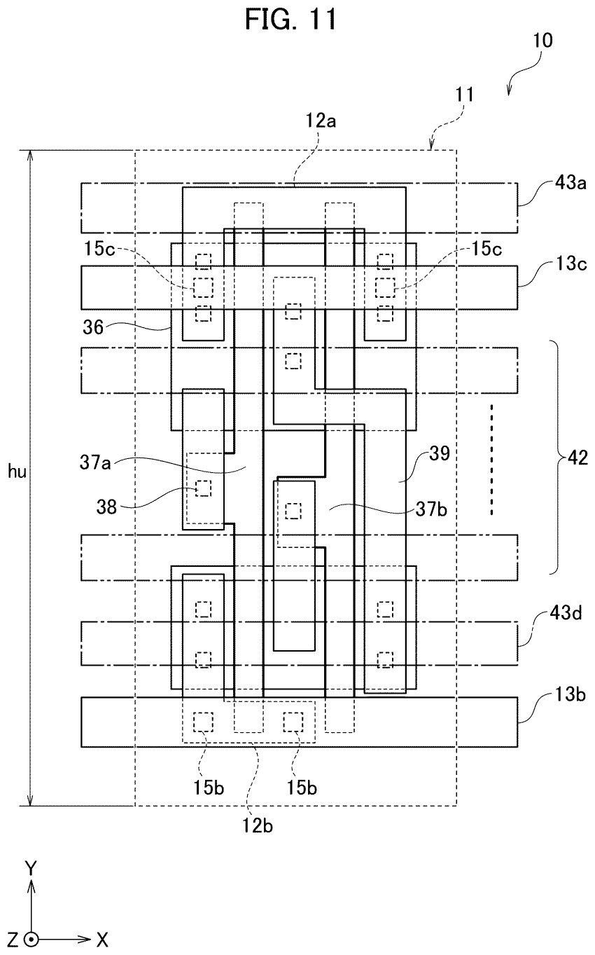

FIG. 11 is a configuration diagram of a configuration in which a standard cell according to the second embodiment and power supply wires are arranged. As an example, a two-input NAND circuit is illustrated. The configuration diagram of the standard cell to be used is the same as the configuration diagram of the standard cell according to the first embodiment illustrated in FIG. 2. The configuration diagram of FIG. 11 illustrates each standard cell 10 arranged in a region in which the power supply wires are arranged as follows: (1) The sub power supply wire 13c is arranged in the out-of-cell wiring region 43c of the M2 layer in FIG. 2. The sub power supply wire 13c is either the first power supply VDD or the third power supply VDD2. (2) The main power supply wire 13b is arranged in the out-of-cell wiring region 43b of the M2 layer in FIG. 2. The main power supply wire 13b is either the second power supply VSS or the fourth power supply VSS2. (3) No power supply wires are arranged in the out-of-cell wiring regions 43a and 43d of the M2 layer in FIG. 2.

The configuration diagram of the second embodiment illustrated in FIG. 11 is different from the first configuration diagram of the first embodiment illustrated in FIG. 4 in the following points: (1) No power supply wires are arranged in the out-of-cell wiring region 43a of the M2layer, and the out-of-cell contacts 15a are not arranged on the power supply access points 45a. (2) The sub power supply wire 13c is arranged in the out-of-cell wiring region 43c of the M2 layer, and the out-of-cell contacts 15c are arranged on the power supply access points 45c.

In this way, the sub power supply wire 13c may be used as a power supply wire on the high potential side in the standard cell 10. Similarly, the sub power supply wire 13d may be used as a power supply wire on the low potential side.

The configuration diagram of the semiconductor device according to the second embodiment, as illustrated in FIG. 10, is different from the configuration diagram of the semiconductor device according to the first embodiment, illustrated in FIG. 1, in the following points: (1) In a part of the standard cell 10 (VDD2) _2 of the standard cell arrangement row 23, the main power supply wire 13a (VDD) is not arranged, and the out-of-cell wiring region 43a of the M2 layer is left as it is. (2) The sub power supply wire 13c (VDD2) is arranged in a part of the standard cell arrangement row 23 in the standard cells 10 (VDD2) _2 and 10 (VDD2) _3. The out-of-cell wiring region 43c of the M2 layer remains in the region of the standard cell arrangement row 23 in which the sub power supply wire 13c (VDD2) is not arranged.

In FIG. 10, the standard cell arrangement rows 20 and 21, in which a pair of power supply wires consisting of one main power supply wire 13a on the high potential side and one main power supply wire 13b on the low potential side are arranged as power supply wires, belong to the first block.

The standard cells 10 (VDD) _1 and 10 (VDD) _4 of the standard cell arrangement row 23, in which a pair of power supply wires consisting of one main power supply wire 13a on the high potential side, and one main power supply wire 13b on the low potential side, are arranged, belong to the first block. The standard cell 10 (VDD2) _2 of the standard cell arrangement row 23 in which a pair of power supply wires consisting of one sub power supply wire 13c on the high potential side, and one main power supply wire 13b on the low potential side, are arranged, belong to the first block. In the standard cell 10 (VDD2) _3 of the standard cell arrangement row 23, a pair of power supply wires consisting of one main power supply wire 13a on the high potential side, and one main power supply wire 13b on the low potential side, and further, one sub power supply wire 13c on the high potential side, are arranged as power supply wires. Standard cell 10 (VDD2) _3 of the standard cell arrangement row 23 belongs to the second block.

As described above, in the configuration diagram of the semiconductor device 101 according to the second embodiment illustrated in FIG. 10, the main power supply wire 13a (VDD) and the sub power supply wire 13c (VDD2) are not arranged at all part of the standard cell arrangement row 23. In a region in which the main power supply wire 13a (VDD) or the sub power supply wire 13c (VDD2) is not arranged, a signal line wire of the M2 layer can be arranged in the out-of-cell wiring regions 43a and 43c of the M2 layer. Thus, more regions in which the signal line wire of the M2 layer can be arranged can be secured.

The flow of the layout design method of the semiconductor device 101 according to the second embodiment illustrated in FIG. 10 is the same as the flow of the layout design method of the semiconductor device 100 according to the first embodiment illustrated in FIG. 7. Furthermore, the layout design system of the semiconductor device 101 according to the second embodiment illustrated in FIG. 10 is the same as the layout design system 200 of the semiconductor device 100 according to the first embodiment illustrated in FIGS. 8 and 9.

### Effect of the Second Embodiment

According to the second embodiment, in the layout design, in addition to the region in which a pair of main power supply wires are arranged, a region in which a pair of main power supply wires and one or more sub power supply wires on the high potential side are arranged is partially provided. By partially providing a region in which the sub power supply wires are arranged, an increase in wiring area can be prevented. Furthermore, in some standard cells, the sub power supply wires are arranged without arranging main power supply wires in the out-of-cell wiring region of the M2 layer. Alternatively, in the standard cell arrangement row, the sub power supply wires are arranged in the out-of-cell wiring regions of some of the standard cells, and the sub power supply wires are not arranged in the out-of-cell wiring regions of the remaining standard cells. By not arranging the main power supply wires or the sub power supply wires, more regions in which the signal line wire of the M2 layer can be arranged can be secured. As a result, the degrees of freedom of the wiring between the standard cells of the P & R is improved, and the frequency of a designer readjusting the position, size, and shape of each power domain, rearranging the power supply wire, and performing the P & R again can be reduced, thereby preventing the repetition of the work in the design process. From another viewpoint, the layout area required for arranging the signal line wire can be reduced.

Moreover, in comparison with the second configuration diagram of the semiconductor device according to the comparative example illustrated in FIG. 18, according to the second embodiment of the present invention, the repetition of the P & R process by adjusting the arrangement of the power domain and the power supply wires can be prevented. Specifically, arrangement of a standard cell using the first power supply VDD and a standard cell using the third power supply VDD2 adjacent to each other in the X direction will be considered. By arranging the power supply wire of the power domain to which one of the standard cells belongs as a sub power supply wire, it is not necessary to insert a gap for separating the power supply wire of the first power supply VDD and the third power supply VDD2 of the M2 layer in the X direction. Thus, the frequency of the designer adjusting the position, size, and shape of the power domain can be reduced.

### Third Embodiment

### Configuration of Semiconductor Device

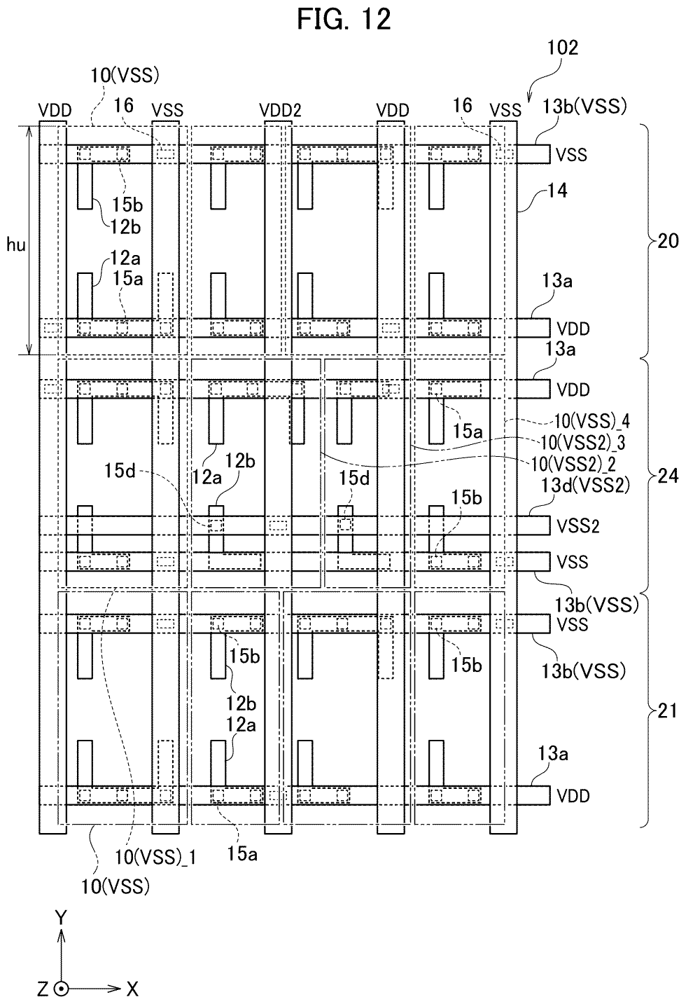

FIG. 12 is a configuration diagram of a semiconductor device according to a third embodiment. The semiconductor device 102 includes the standard cell arrangement rows 20, 21 and a standard cell arrangement row 24, the main power supply wires 13a and 13b of the M2 layer, the sub power supply wire 13d of the M2 layer, the power supply wires 14 of the M3 layer, the out-of-cell contacts 15a, 15b, and 15d, and contacts 16.

The standard cells 10 are arranged in the X direction in the standard cell arrangement rows 20, 21, and 24. The main power supply wires 13a, 13b and the sub power supply wire 13d are arranged in the X direction outside the standard cells for each of the standard cell arrangement rows 20, 21, and 24. The power supply wires 14 are arranged in the Y direction. The out-of-cell contacts 15a, 15b, and 15d are arranged outside the standard cell, and connect one of the intra-cell power supply wires 12a and 12b of the M1 layer to one of the main power supply wires 13a, 13b, and the sub power supply wire 13d of the M2 layer. The contacts 16 connect one of the main power supply wires 13a, 13b and the sub power supply wire 13d of the M2 layer to the power supply wires 14 of the M3 layer.

The main power supply wires 13b that supply the second power supply VSS are denoted as main power supply wires 13b (VSS), and the main power supply wires 13b that supply the fourth power supply VSS2 are denoted as main power supply wires 13b (VSS2). The sub power supply wire 13d that supplies the fourth power supply VSS2 is denoted as a sub power supply wire 13d (VSS2).

The configuration of the standard cells 10 is the same, regardless of whether the second power supply VSS or the fourth power supply VSS2 is used. When the standard cells 10 are arranged, the standard cells 10 are connected to the power supply to be used, outside the standard cells 10. When the standard cells 10 use the second power supply VSS as the power supply on the low potential side, they are denoted as the standard cells 10 (VSS), and when the standard cells use the fourth power supply VSS2, they are denoted as the standard cells 10 (VSS2).

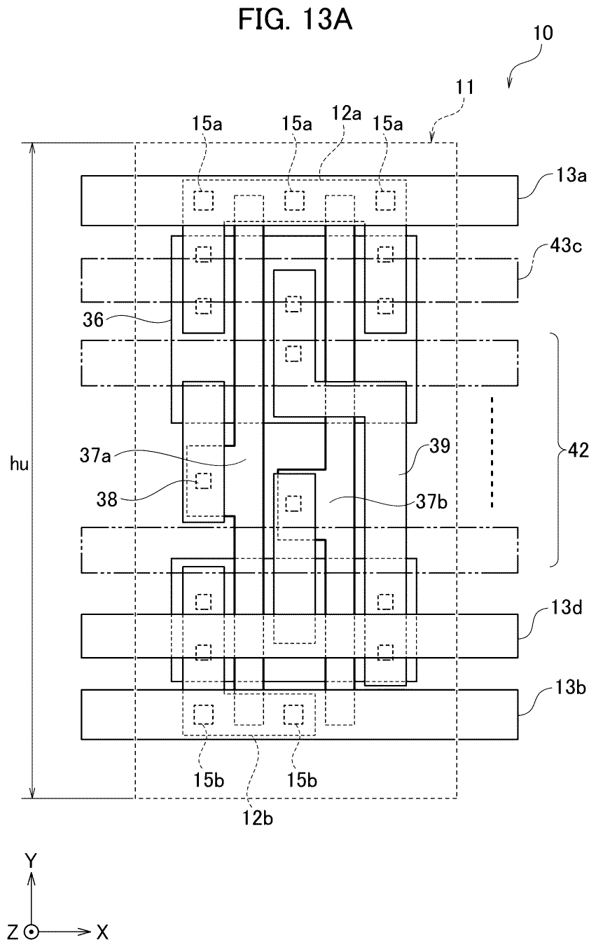

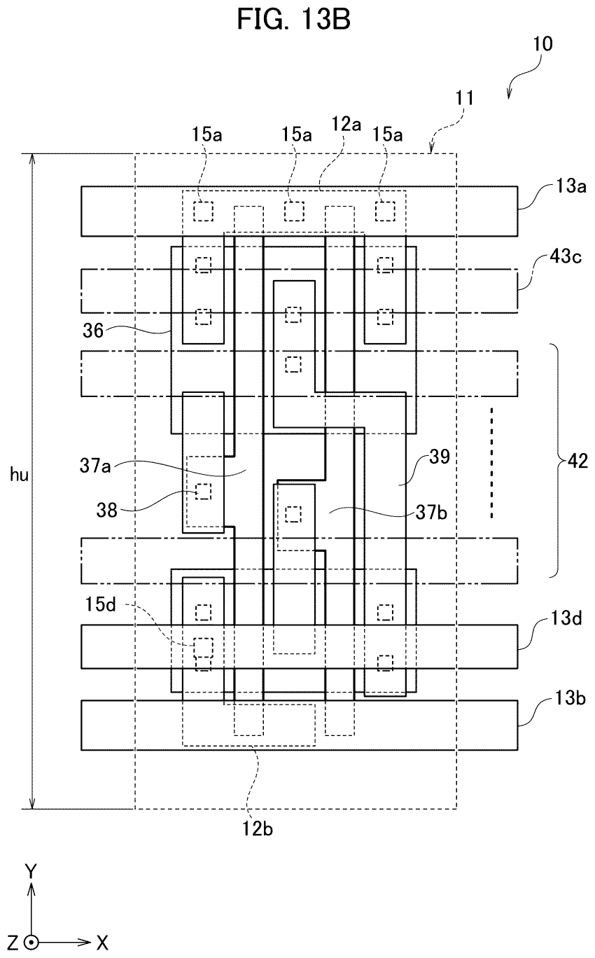

FIG. 13A is a first configuration diagram in which a standard cell according to a third embodiment and power supply wires are arranged. The first configuration diagram illustrates the standard cell 10 arranged in a region in which the power supply wires are arranged as follows. (1) The main power supply wires 13a and 13b are arranged in the out-of-cell wiring regions 43a and 43b of the M2 layer in FIG. 2, respectively. The main power supply wire 13a is either the first power supply VDD or the third power supply VDD2. The main power supply wire 13b is either the second power supply VSS or the fourth power supply VSS2. (2) The sub power supply wire 13d is arranged in the out-of-cell wiring region 43d of the M2 layer in FIG. 2. The sub power supply wire 13d is a power supply wire for supplying one of the second power supply VSS or the fourth power supply VSS2 which is different from the power supply supplied by the main power supply wire 13b. (3) No power supply wires are arranged in the out-of-cell wiring region 43c of the M2 layer in FIG. 2.

The standard cell 10 uses the main power supply wire 13a and the main power supply wire 13b. The first configuration diagram of the third embodiment illustrated in FIG. 13A is different from the first configuration diagram of the first embodiment illustrated in FIG. 4 in that not only the main power supply wire 13b but also the sub power supply wire 13d are arranged as the power supply wire on the low potential side. In relation to the difference, process (g), performed when the standard cell 10 is arranged in the first configuration diagram of the first embodiment illustrated in FIG. 4, is the process of separating the intra-cell power supply wire 12b and the sub power supply wire 13d in the first configuration diagram of the third embodiment illustrated in FIG. 13A. Other processes are the same as those in FIG. 4, and the description thereof will be omitted.

FIG. 13B is a second configuration diagram in which a standard cell according to the third embodiment and the power supply wires are arranged. In the second configuration diagram, the configuration of the power supply wires in the region in which the standard cell 10 is arranged is the same as that in the first configuration diagram illustrated in FIG. 13A.

The second configuration diagram illustrated in FIG. 13B is different from the first configuration diagram illustrated in FIG. 13A in that the standard cell 10 uses not the main power supply wire 13b but the sub power supply wire 13d as a power supply wire on the low potential side. In relation to the difference, the process (a) and processes (e) to (g), performed when the standard cell 10 is arranged in the first configuration diagram according to the first embodiment illustrated in FIG. 4, are varied as follows.
(a) The main power supply wire 13a and the sub power supply wire 13d are selected as a pair of power supply wires used by the standard cell 10.
(e) The power supply access points 45d corresponding to the sub power supply wire 13d used by the standard cell 10 is selected from the power supply access points 45b and 45d illustrated in FIG. 2.
(f) The out-of-cell contact 15d is arranged on the power supply access point 45d that is selected, so that the intra-cell power supply wire 12b of the M1 layer is connected to the sub power supply wire 13d.
(g) An insulating film is arranged on the power supply access points 45b that are not selected, so that the intra-cell power supply wire 12b of the M1 layer is separated from the main power supply wire 13b.

In the standard cell arrangement rows 20 and 21 of FIG. 12, the first configuration illustrated in FIG. 4 in which a standard cell according to the first embodiment and the power supply wires are arranged, is used.

The first configuration illustrated in FIG. 13A in which the standard cell according to the third embodiment and the power supply wires are arranged, and the second configuration illustrated in FIG. 13B in which the standard cell according to the third embodiment and the power supply wires are arranged, are used in the standard cell arrangement row 24 of FIG. 12. The main power supply wires 13a and 13b (VSS), and the sub power supply wire 13d (VSS2) of the M2 layer, are arranged outside the standard cell 10 in the out-of-cell wiring regions 43a, 43b, and 43d of the M2 layer in FIG. 2.

Of the four standard cells 10 arranged in the standard cell arrangement row 24, the first configuration illustrated in FIG. 13A is used in the standard cells 10 (VSS) _1 and 10 (VSS) _4. In the standard cells 10 (VSS) _1 and 10 (VSS) _4, the main power supply wire 13b (VSS) on the low potential side, and the intra-cell power supply wire 12b of the M1 layer, are connected. For this purpose, the out-of-cell contacts 15b are arranged outside the standard cell 10 at the positions of the power supply access points 45b in FIG. 2.

The second configuration illustrated in FIG. 13B is used in the standard cells 10 (VSS2) _2 and 10 (VSS2) _3. In the standard cells 10 (VSS2) _2 and 10 (VSS2) _3, the sub power supply wire 13d (VSS2) on the low potential side, and the intra-cell power supply wire 12b of the M1 layer, are connected. For this purpose, the out-of-cell contact 15d is arranged outside the standard cell 10 at the position of the power supply access point 45d in FIG. 2.

In the standard cell arrangement rows 20 and 21 in FIG. 12 which belong to the first block, a pair of power supply wires consisting of one main power supply wire 13a on the high potential side, and one main power supply wire 13b on the low potential side, are arranged as power supply wires. In the standard cell arrangement row 24 in FIG. 12 which belongs to the second block, a pair of power supply wires consisting of one main power supply wire 13a on the high potential side, and one main power supply wire 13b on the low potential side, are arranged, and further, one sub power supply wire 13d on the low potential side is arranged, as power supply wires.

The flow of the layout design method of the semiconductor device 102 according to the third embodiment illustrated in FIG. 12 is the same as the flow of the layout design method of the semiconductor device 100 according to the first embodiment illustrated in FIG. 7. Furthermore, the layout design system of the semiconductor device 102 according to the third embodiment is the same as the layout design system 200 of the semiconductor device 100 according to the first embodiment illustrated in FIGS. 8 and 9.

In the semiconductor device 102 according to the third embodiment illustrated in FIG. 12, as in the semiconductor device 101 according to the second embodiment illustrated in FIG. 10, the sub power supply wire 13d may be arranged instead of the main power supply wire 13b in the out-of-cell wiring regions 43b and 43d of some of the standard cells 10. Alternatively, in the standard cell arrangement row 24, the sub power supply wire 13d may be arranged in the out-of-cell wiring region 43d of some of the standard cells 10, and the sub power supply wire 13d may not be arranged in the out-of-cell wiring region 43d of the remaining standard cells 10. In the out-of-cell wiring region 43d of the M2 layer in which the sub power supply wire 13d is not arranged, the signal line wire of the M2 layer may be arranged.

### Effect of the Third Embodiment

According to the third embodiment, in the layout design, in addition to the region in which a pair of main power supply wires are arranged, a region in which a pair of main power supply wires and one or more low-potential side sub power supply wires are arranged, is partially provided. By partially providing a region in which the sub power supply wires are arranged, an increase in wiring area can be prevented. In a partially provided region, standard cells using any of the power supplies can be arranged. As a result, the degrees of freedom of P & R can be improved, and the frequency of a designer readjusting the position, size, and shape of each power domain, rearranging the power supply wires, and performing the P & R again can be reduced, and the repetition of work in the design process can be prevented.

### Fourth Embodiment

### Structure of Semiconductor Device

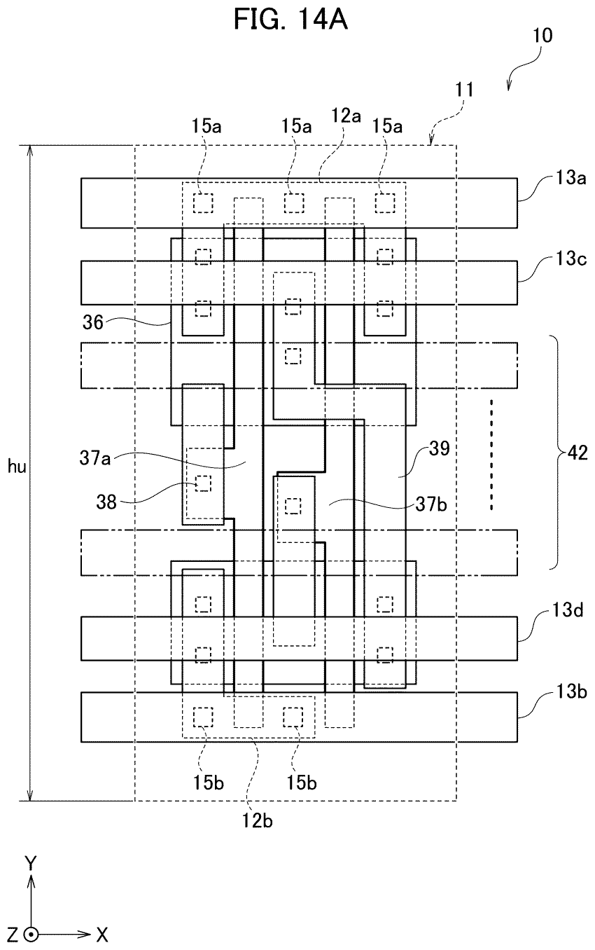

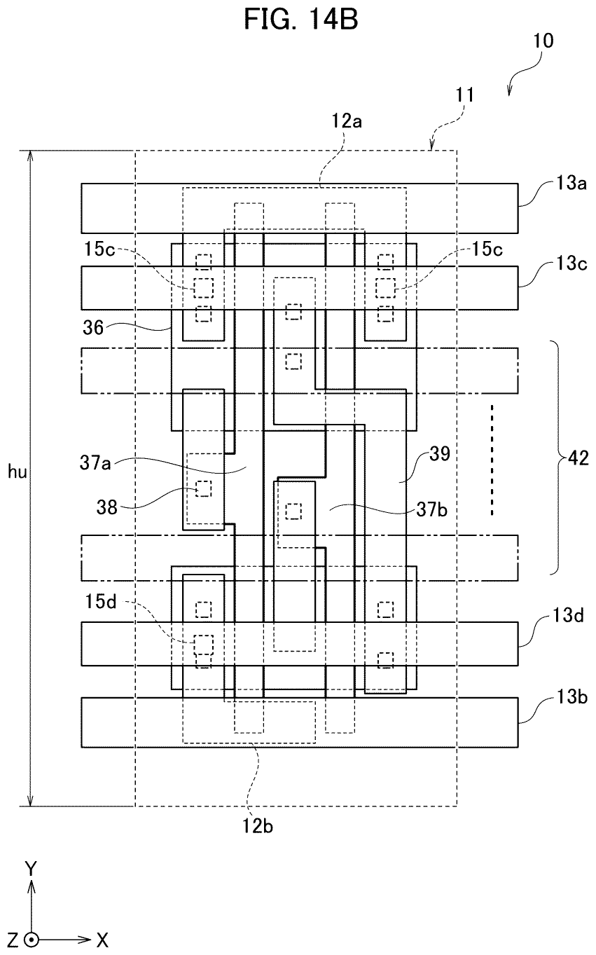

FIG. 14A is a first configuration diagram in which a standard cell according to a fourth embodiment and the power supply wires are arranged. The first configuration diagram illustrates the standard cell 10 arranged in a region in which the power supply wires are arranged as follows: (1) The main power supply wires 13a and 13b are arranged in the out-of-cell wiring regions 43a and 43b of the M2 layer in FIG. 2, respectively. (2) The sub power supply wires 13c and 13d are arranged in the out-of-cell wiring regions 43c and 43d of the M2 layer in FIG. 2, respectively.

The standard cell 10 uses the main power supply wires 13a and 13b. The first configuration diagram of the fourth embodiment illustrated in FIG. 14A is different from the first configuration diagram of the first embodiment illustrated in FIG. 4 in that the sub power supply wire 13c is also arranged as a power supply wire on the high potential side, and the sub power supply wire 13d is also arranged as a power supply wire on the low potential side. In relation to the difference, in the first configuration diagram of the fourth embodiment illustrated in FIG. 14A, the processes (d) and (g), performed when the standard cell 10 is arranged in the first configuration diagram of the first embodiment illustrated in FIG. 4, are varied as follows.
(d) An insulating film is arranged on the power supply access points 45c that are not selected, so that the intra-cell power supply wire 12a of the M1 layer is separated from the sub power supply wire 13c.
(g) An insulating film is arranged on the power supply access point 45d that is not selected, so that the intra-cell power supply wire 12b of the M1 layer is separated from the sub power supply wire 13d.

FIG. 14B is a second configuration diagram in which a standard cell according to the fourth embodiment and the power supply wires are arranged. In the second configuration diagram, the configuration of the power supply wires in the region in which the standard cell 10 is arranged, is the same as that in the first configuration diagram illustrated in FIG. 14A.

The second configuration diagram illustrated in FIG. 14B is different from the first configuration diagram illustrated in FIG. 14A in that the standard cell 10 uses the sub power supply wire 13c as a power supply wire on the high potential side, and the sub power supply wire 13d as a power supply wire on the low potential side. In relation to the difference, in the second configuration diagram illustrated in FIG. 14B in the fourth embodiment, the processes (a) to (g), performed when the standard cell 10 is arranged in the first configuration diagram illustrated in FIG. 4, are varied as follows.
(a) The sub power supply wires 13c and 13d are selected as a pair of power supply wires used by the standard cell 10.
(b) The power supply access points 45c corresponding to the sub power supply wire 13c used by the standard cell 10 is selected from the power supply access points 45a and 45c in FIG. 2.
(c) The out-of-cell contacts 15c are arranged on the power supply access points 45c that are selected, so that the intra-cell power supply wire 12a of the M1 layer is connected to the sub power supply wire 13c.
(d) An insulating film is arranged on the power supply access points 45a that are not selected, so that the intra-cell power supply wire 12a of the M1 layer is separated from the main power supply wire 13a.
(e) The power supply access point 45d corresponding to the sub power supply wire 13d used by the standard cell 10 is selected from the power supply access points 45b and 45d in FIG. 2.
(f) The out-of-cell contact 15d is arranged on the power supply access point 45d that is selected, so that the intra-cell power supply wire 12b and the sub power supply wire 13d of the M1 layer are connected.
(g) An insulating film is arranged on the power supply access points 45b that are not selected, so that the intra-cell power supply wire 12b of the M1 layer is separated from the main power supply wire 13b.

Note that, the first configuration diagram of FIG. 14A illustrates a case in which the main power supply wires are used for both the high-potential side power supply wire, and the low-potential side power supply wire, and the second configuration diagram of FIG. 14B illustrates a case in which the sub power supply wires are used for both the high-potential side power supply wire and the low-potential side power supply wire. As another combination, there is a case in which a main power supply wire is used for the high-potential side power supply wire, and a sub power supply wire is used for the low-potential side power supply wire. This corresponds to a case in which the sub power supply wire 13c on the high-potential side is additionally arranged in the out-of-cell wiring region 43c in FIG. 13B, as illustrated in FIG. 6A. The configuration can be uniquely derived from FIG. 13B and FIG. 6A, the description thereof will be omitted.

As another combination, there is a case in which the sub power supply wire is used as a power supply wire on the high-potential side power supply wire, and the main power supply wire is used as a power supply wire on the low-potential side power supply wire. This corresponds to a case in which the sub power supply wire 13d on the low potential side is additionally arranged in the out-of-cell wiring region 43d of FIG. 6B, as illustrated in FIG. 13A. The configuration can be uniquely derived from FIGS. 6B and 13A, the description thereof will be omitted.

Standard cell arrangement rows can be obtained by arranging a plurality of the configurations illustrated in FIGS. 14A and 14B in the X direction so as to be in contact with each other by each boundary line 11. In the standard cell arrangement rows, for each of the standard cells 10, one of the main power supply wire 13a and the sub power supply wire 13c used by the standard cell 10 is selected as a power supply wire on the high potential side, and connected to the intra-cell power supply wire 12a. Further, for each standard cell 10, one of the main power supply wire 13b and the sub power supply wire 13d used by the standard cell 10 is selected as a power supply wire on the low potential side, and connected to the intra-cell power supply wire 12b. Since the configuration of the standard cell arrangement row can be derived by combining the configuration diagram of the semiconductor device 100 according to the first embodiment illustrated in FIG. 1 with the configuration diagram of the semiconductor device 102 according to the third embodiment illustrated in FIG. 12, the description thereof will be omitted.

### Effect of the Fourth Embodiment

According to the fourth embodiment, in the layout design, in addition to the region in which a pair of main power supply wires are arranged, a region in which a pair of main power supply wires, one or more sub power supply wires on the high potential side, and one or more sub power supply wires on the low potential side, are arranged is partially provided. By partially providing a region in which sub power supply wires are arranged, an increase in wiring area can be prevented. In the partially provided region, standard cells using any of the power supplies can be arranged. As a result, the degrees of freedom of P & R can be improved, and the frequency of a designer readjusting the position, size, and shape of each power domain, rearranging the power supply wires, and performing the P & R again can be reduced, and the repetition of work in the design process can be prevented.

### Other Embodiments

Although several embodiments of the present invention have been described, these embodiments are presented as examples, and are not intended to limit the scope of the invention. These novel embodiments can be embodied in various other forms, and various omissions, substitutions, and changes can be made without departing from the gist of the invention. These embodiments and variations thereof are included in the scope and gist of the invention, and are included in the scope equivalent to the invention described in the claims.

For example, in the configurations of the standard cell and the semiconductor device according to some embodiments of the present invention, a logic circuit using a pair of power supplies, particularly a NAND circuit, has been described. However, the logic circuit may be a level shifter using a pair of power supplies, and one or more power supplies whose voltage is boosted or lowered. The logic circuit may be a flip-flop using a pair of power supplies and one or more power supplies whose supply to the logic circuit is cut off during standby, and maintaining a value even when the power supply is cut off.

For example, in the configurations of the standard cells and the semiconductor devices according to some embodiments of the present invention, a case in which the dimension of the standard cell in the Y direction is the height per unit hu has been described. However, a multi-height cell may be included in a plurality of types of standard cells and the dimension in the Y direction is an integral multiple of the height per unit hu. The multi-height cell is also included in the scope and gist of the present invention, since it uses a pair of power supplies, and the positions of the power supply wires in the Y direction are common to the standard cells in which the dimension in the Y direction is a height per unit hu. For example, a first standard cell having a dimension of a natural number m times the height per unit hu in the Y direction, and a second standard cell having a dimension of a natural number n times different from a natural number m times the height per unit hu in the Y direction, may be arranged.

For example, in the configurations of the standard cells and the semiconductor device according to some embodiments of the present invention, a case in which the main power supply wires are arranged in the out-of-cell wiring regions 43a and 43b of the M2 layer, and the sub power supply wires are arranged in the out-of-cell wiring regions 43c and 43d of the M2 layer, has been illustrated. However, the main power supply wires may be arranged in the out-of-cell wiring regions 43c and 43d of the M2 layer, and the sub power supply wires may be arranged in the out-of-cell wiring regions 43a and 43b of the M2 layer.

What is claimed is:

1. A standard cell library comprising at least a first standard cell and a second standard cell used in a design of a standard cell method in which standard cells are arranged to configure a semiconductor integrated circuit, wherein:
the first standard cell has a dimension of a natural number m times a height per unit in a first direction, and has a first internal power supply wire arranged therein;
the second standard cell has a dimension of a natural number n times the height per unit in the first direction, and has a second internal power supply wire arranged therein;
the first standard cell and the second standard cell are configured such that the first internal power supply wire is separated from the second internal power supply wire when the first standard cell and the second standard cell are arranged adjacent to each other in a second direction orthogonal to the first direction;
the first standard cell has a first wiring region in which a first external power supply wire can be arranged and which extends in a second direction, and a first connectable position in which the first external power supply wire and the first internal power supply wire can be connected;
the second standard cell has a second wiring region in which the first external power supply wire can be arranged and which extends in the second direction, and a second connectable position in which the first external power supply wire and the second internal power supply wire can be connected; and
the first wiring region and the second wiring region are connectable adjacent to each other.

2. The standard cell library according to claim 1, wherein the first wiring region of the first standard cell, and the second wiring region of the second standard cell, are located at substantially equal positions in the first direction.

3. The standard cell library according to claim 1, comprising a third standard cell which can be arranged adjacent to the first standard cell in the first direction.

4. The standard cell library according to claim 1, wherein the natural number m and the natural number n are different natural numbers.

5. The standard cell library according to claim 1, wherein the first standard cell comprises:
a third internal power supply wire separated from the first internal power supply wire;
a third wiring region in which a second external power supply wire can be arranged, and which extends in the second direction;
a third connectable position in which the second external power supply wire and the third internal power supply wire can be connected;
a fourth wiring region in which a third external power supply wire can be arranged, and which extends in the second direction;
a fourth connectable position in which the third external power supply wire and the third internal power supply wire can be connected.

6. The standard cell library according to claim 5, wherein, when the first standard cell is arranged,
the first connectable position or the second connectable position, corresponding to an external power supply wire out of the first external power supply wire and the second external power supply wire which is used by the first standard cell, is selected;
the first external power supply wire and the first internal power supply wire are connected at the first connectable position that is selected; or the second external power supply wire and the first internal power supply wire are connected at the second connectable position that is selected; and
the third external power supply wire is connected to the third internal power supply wire at the fourth connectable position.

7. The standard cell library according to claim 1, wherein:
the first internal power supply wire comprises a first portion arranged in the first direction and a second portion arranged in the second direction; and
the number of the first connectable positions is greater than the number of the first portions.

8. A semiconductor device, comprising:
a first standard cell having a dimension of a natural number m times a height per unit in a first direction, and having a first internal power supply wire arranged therein;
a second standard cell having a dimension of a natural number n times the height per unit in the first direction, and having a second internal power supply wire, which is separated from the first internal power supply wire, arranged therein, the second standard cell being adjacent to the first standard cell in a second direction orthogonal to the first direction;
a first external power supply wire extending in the second direction;
a first contact connecting the first internal power supply wire and the first external power supply wire at a first connectable position; and
a second contact connecting the second internal power supply wire and the first external power supply wire at a second connectable position.

9. The semiconductor device according to claim 8,
wherein the first connectable position and the second connectable position are located at substantially equal positions in the first direction.

10. The semiconductor device according to claim 8, comprising a third standard cell which can be arranged adjacent to the first standard cell in the first direction.

11. The semiconductor device according to claim 8, wherein the natural number m and the natural number n are different natural numbers.

12. The semiconductor device according to claim 8, wherein:
the first standard cell comprises a third internal power supply wire, separated from the first internal power supply wire and the second internal power supply wire, therein; and
the first standard cell further comprises outside:
a second external power supply wire extending in the second direction,
a third external power supply wire extending in the second direction, and
a third contact connecting the third internal power supply wire and the third external power supply wire at a fourth connectable position.

13. The semiconductor device according to claim 8, wherein:
the first internal power supply wire comprises a first portion arranged in the first direction, and a second portion arranged in the second direction; and
the number of the first contacts is greater than the number of the first portions.
